(19) United States
(12) Patent Application Publication
(10) Pub. No.: US 2026/0213979 A1
(43) Pub. Date: Jul. 23, 2026

(54) NODE DEVICE AND METHOD THEREOF IN COMMUNICATION SYSTEM

(71) Applicant: SAMSUNG ELECTRONICS CO., LTD., Suwon-si, Gyeonggi-do (KR)

(72) Inventors: Nan QU, Beijing (CN); Di SU, Beijing (CN); Peng LIN, Beijing (CN)

(21) Appl. No.: 19/144,370

(22) PCT Filed: Dec. 28, 2023
(86) PCT No.: PCT/KR2023/021903

§ 371 Date: Jun. 27, 2025

(30) Foreign Application Priority Data
Dec. 30, 2022 (CN) 202211739260.1

(51) Int. Cl. H04L 25/02; H04L 5/00

(52) U.S. Cl. CPC H04L 25/0202; H04L 5/0053

(57) ABSTRACT

The disclosure relates to a method and device for detecting at least one target, comprising: transmitting a sensing signal; obtaining a first channel estimation result corresponding to an echo signal of the sensing signal; obtaining a second channel estimation result based on the first channel estimation result; based on the first channel estimation result and the second channel estimation result, performing over-threshold detection based on a threshold value being used to obtain an index subset related to target(s); and obtaining an over-threshold detection result based on the index subset related to the target(s).

### TECHNICAL FIELD

The disclosure relates to wireless communication, and more particularly, to a method and apparatus for target detection.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE

### Technical Problem

In line with development of the communication systems, there is a need for effective communication method.

The technical subjects pursued in the disclosure may not be limited to the above mentioned technical subjects, and other technical subjects which are not mentioned may be clearly understood, through the following descriptions, by those skilled in the art to which the disclosure pertains.

### Technical Solution

A method performed by a node in a communication system is provided. The method includes: transmitting a sensing signal; obtaining a first channel estimation result corresponding to an echo signal of the sensing signal; windowing the first channel estimation result to obtain a second channel estimation result; performing over-threshold detection according to a threshold value based on the first channel estimation result and the second channel estimation result to obtain an index subset related to a target; and obtaining a detection result about the target based on the index subset.

According to an embodiment of the disclosure, there is provided a method performed by a node in a communication system, including: transmitting a sensing signal; obtaining a first channel estimation result corresponding to an echo signal of the sensing signal; windowing the first channel estimation result to obtain a second channel estimation result; based on the first channel estimation result and the second channel estimation result, performing over-threshold detection according to a threshold value to obtain an index subset related to target(s); and obtaining a detection result about the target(s) based on the index subset.

In one implementation, the over-threshold detection includes: obtaining a first envelope of the first channel estimation result and a second envelope of the second channel estimation result; and performing the over-threshold detection according to the threshold value based on the first envelope and the second envelope.

In one implementation, the over-threshold detection is performed according to the threshold value based on a difference between the first envelope and the second envelope.

According to an embodiment of the disclosure, there is provided a method performed by a node in a communication system, including: transmitting a sensing signal; obtaining a first channel estimation result corresponding to an echo signal of the sensing signal; windowing the first channel estimation result to obtain a second channel estimation result; filtering the second channel estimation result to obtain a third channel estimation result; based on the second channel estimation result and the third channel estimation result, performing over-threshold detection according to a threshold value to obtain an index subset related to a target; and obtaining a detection result about the target based on the index subset.

In one implementation, the second channel estimation result is channel estimation results in two dimensions, and the method further includes: averaging the second channel estimation result in one of the dimensions to obtain an averaged second channel estimation result, wherein the filtering of the second channel estimation result to obtain the third channel estimation result includes filtering the averaged second channel estimation result to obtain the third channel estimation result, and wherein the over-threshold detection includes performing the over-threshold detection based on a difference between the averaged second channel estimation result and the third channel estimation result and the threshold value.

In one implementation, the second channel estimation result is channel estimation results in two dimensions, and wherein the filtering and over-threshold detection include: performing first filtering on the second channel estimation result in one of the two dimensions; performing first over-threshold detection to obtain a third index set according to a difference between the first filtered channel estimation result and the second channel estimation result and the first threshold; obtaining a subset of the second channel estimation result corresponding to the third index set for another of the two dimensions; performing second filtering on the subset of the second channel estimation result in the other dimension; performing second over-threshold detection to obtain the index subset according to a difference between the filtered subset of the second channel estimation result and the subset of the second channel estimation result and a second threshold.

In one implementation, the filtering is performed by using a two-dimensional filter.

In one implementation, the filtering includes filtering the second channel estimation result by using a plurality of different filters respectively to obtain a plurality of third channel estimation results, wherein the over-threshold detection includes: for each third channel estimation result of the plurality of third channel estimation results, based on a difference between the third channel estimation result and the second channel estimation result and a threshold value, performing the over-threshold detection to obtain a third index subset related to the third channel estimation result, and wherein the index subset is a union of the third index subsets related to the third channel estimation results.

In one implementation, the filter is a moving average filter or a cyclic moving average filter.

In one implementation, a filter length corresponding to the filtering is related to a cross-sectional area of the target that a system expects to detect or a range of the cross-sectional area of the target that the system expects to detect.

In one implementation, the threshold value is obtained by: obtaining the threshold value according to a statistical characteristic of a noise related to reception of the echo signal; or generating a first random noise based on the statistical characteristic of the noise, filtering the first random noise to obtain a second noise, and obtaining the threshold value based on a noise difference between the second noise and the first random noise.

In one implementation, the threshold value obtained based on the difference between the second noise and the first random noise is a maximum value of the noise difference, or a sum of the maximum value and a typical value.

In one implementation, the typical value is inversely proportional to the filter length corresponding to the filtering.

In one implementation, the obtaining of the detection result about the target based on the index subset includes: obtaining a second index subset related to the target based on the first channel estimation result and the index subset; obtaining the detection result about the target based on the second index subset.

In one implementation, the second index subset includes: a first index of the index subset to which the first channel estimation result corresponds is a maximum value, and a third index, which includes one or more indexes determined within a first range corresponding to a second index based on the first channel estimation result, the second index being an index of the index subset to which the first channel estimation result corresponds is not the maximum value, wherein each index within the first range are from the index subset and a difference between the index and the second index is not greater than a first threshold.

In one implementation, the third index includes: an index of the maximum value within the first range corresponding to the second index; and/or an index within the first range corresponding to the second index, a difference between the first channel estimation result corresponding to the index and the first channel estimation result corresponding to the second index being not less than a second threshold, wherein the second threshold is less than or equal to zero.

In one implementation, the detection result includes at least one of: the number of targets obtained according to the number of indexes in the index subset; a distance and/or speed of the target determined based on values of the indexes in the index subset.

According to an embodiment of the disclosure, there is provided a node device including a transceiver configured to transmit and/or receive signals; and a processor coupled with the transceiver and configured to perform a method according to an embodiment of the disclosure.

### Advantageous Effects

The present disclosure provides an effective and efficient method for communication associated with nodes. Advantageous effects obtainable from the disclosure may not be limited to the above mentioned effects, and other effects which are not mentioned may be clearly understood, through the following descriptions, by those skilled in the art to which the disclosure pertains.

### DESCRIPTION OF DRAWINGS

FIG. 1 is an overall structure of a wireless network;

FIGS. 2A and 2B are wireless transmission and reception paths;

FIGS. 3A and 3B are structural diagrams of a UE and a base station, respectively;

FIGS. 4A-4C are exemplary schematic diagrams of method 1 according to an embodiment of the disclosure;

FIGS. 5A-5C are exemplary schematic diagrams of method 2 according to an embodiment of the disclosure;

FIGS. 6A-6B are exemplary schematic diagrams of method 3 according to an embodiment of the disclosure;

FIG. 7 is an exemplary schematic diagram of method 3 according to an embodiment of the disclosure;

FIG. 8 is a simulation result diagram of a method according to an embodiment of the disclosure;

FIG. 9 is an example hardware block diagram of a device according to an embodiment of the disclosure.

### MODE FOR INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those of ordinary skills in the art to which the disclosure belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one implementation” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those of ordinary skills in the art will understand that the main points of the disclosure can also be applied to other communication systems with similar technical backgrounds and channel formats with slight modifications without departing from the scope of the disclosure.

In the description of the disclosure, when it is considered that some detailed explanations about functions or configurations may unnecessarily obscure the essence of the disclosure, these detailed explanations will be omitted. All terms (including descriptive or technical terms) used herein should be interpreted as having apparent meanings to those of ordinary skill in the art. However, these terms may have different meanings according to the intention of those of ordinary skill in the art, precedents or the emergence of new technologies, and therefore, the terms used herein must be defined based on the meanings of these terms together with the description throughout the specification. Hereinafter, for example, the base station may be at least one of a gNode B, an eNode B, a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) may be a wireless transmission path through which signals are transmitted from a base station to a terminal, and the uplink (UL) may be a wireless transmission path through which signals are transmitted from a terminal to a base station.

Hereinafter, the embodiments of the disclosure will be described in detail with reference to the accompanying drawings. It should be noted that the same reference numerals in different drawings will be used to refer to the same elements already described.

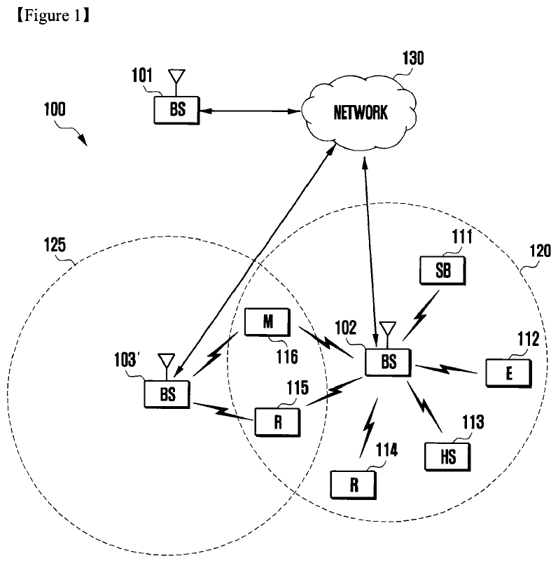

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

The following description with reference to the accompanying drawings is provided to facilitate a comprehensive understanding of various embodiments of the disclosure defined by the claims and their equivalents. This description includes various specific details to facilitate understanding but should only be considered as exemplary. Therefore, those of ordinary skills in the art will recognize that various changes and modifications can be made to the various embodiments described herein without departing from the scope and spirit of the disclosure. In addition, for the sake of clarity and conciseness, descriptions of well-known functions and structures may be omitted.

The terms and expressions used in the following specification and claims are not limited to their dictionary meanings, but are only used by the inventors to enable a clear and consistent understanding of the disclosure. Therefore, it should be apparent to those of ordinary skills in the art that the following descriptions of various embodiments of the disclosure are provided for illustration purposes only and are not intended to limit the purposes of the disclosure as defined in the appended claims and their equivalents.

It should be understood that singular forms of “a”, “an” and “the” include plural referents unless the context clearly indicates otherwise. Thus, for example, a reference to “a component surface” includes a reference to one or more such surfaces.

The terms “include” or “may include” refer to the existence of a corresponding disclosed function, operation or component that can be used in various embodiments of the disclosure, and do not limit the existence of one or more additional functions, operations or features. In addition, the terms “including” or “having” can be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning as those understood by those of ordinary skills in the art in this disclosure. Common terms, as defined in dictionaries, are interpreted as having meanings consistent with the context in the relevant technical fields, and should not be interpreted in an idealized or overly formal way unless explicitly defined in this disclosure.

The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

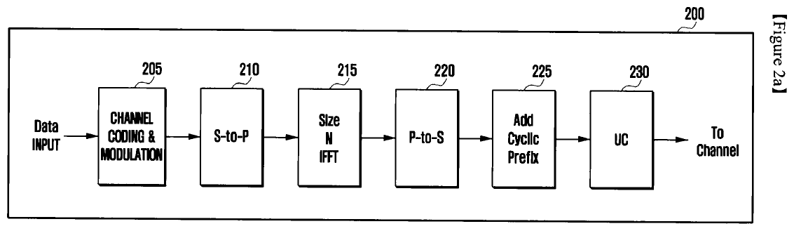

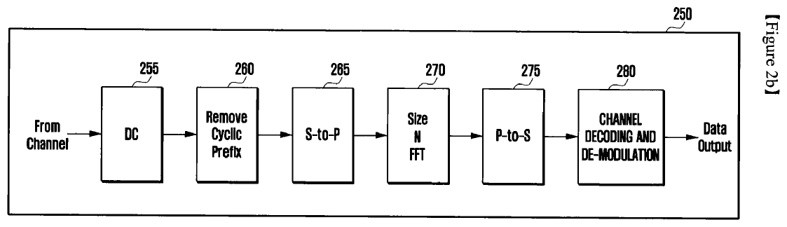

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

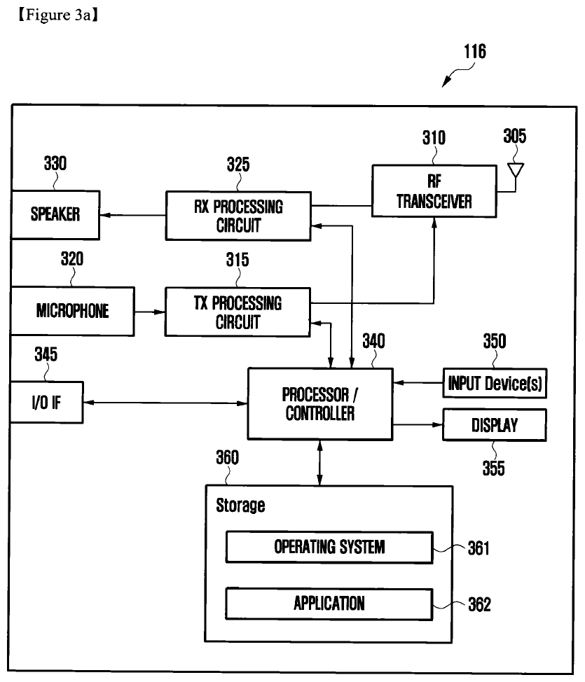

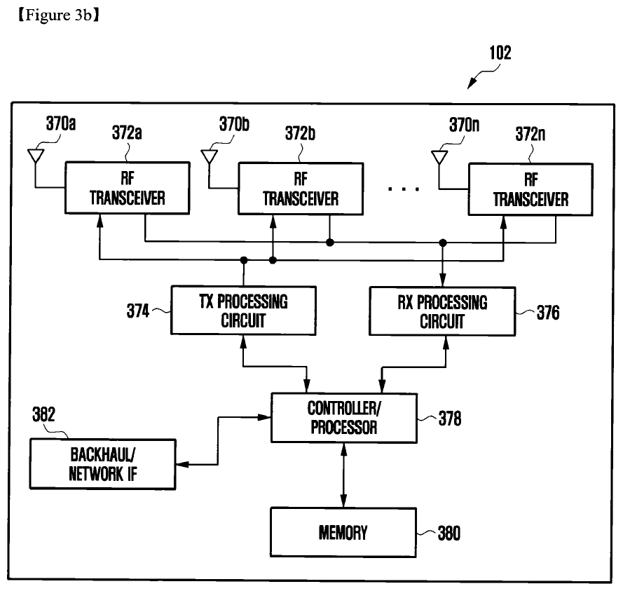

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Exemplary embodiments of the disclosure are further described below with reference to the accompanying drawings.

Text and drawings are provided as examples only to help readers understand the disclosure. They are not intended and should not be construed to limit the scope of the disclosure in any way. Although certain embodiments and examples have been provided, based on the disclosure herein, it is obvious to those of ordinary skills in the art that changes can be made to the illustrated embodiments and examples without departing from the scope of this disclosure.

In addition, the “/” used herein means “or” unless the context clearly indicates otherwise.

### Example 1

The demand for wireless data is increasing in the production activities of human society, and the spectrum is becoming a scarce resource. How to improve the spectrum utilization rate of communication systems has always been a hot issue for practitioners. At present, the low-frequency resources of wireless communication are crowded, and the operating frequency band of communication systems is gradually developing towards higher frequency, which will inevitably conflict with radar systems that originally worked in a higher frequency band. There is a very high similarity between the cellular communication system and the radar system in terms of background theoretical knowledge and hardware structure. Therefore, the integration of the cellular communication system and the radar system can be used as a potential means to improve the spectrum efficiency. At the same time, the communication system and the radar system may also complement each other in performance to achieve mutual benefit and win-win results. Therefore, the integration of communication sensing (hereinafter referred to as sensing), as a hot research direction in the communication field, has become one of 6G candidate technologies. The core of sensing systems is to use the same hardware device, on the basis of ensuring the communication function, at the expense of as few resources as possible, to realize the sensing function of the surrounding environment. At this time, the communication node can also have the function of sensing, and the content of sensing includes the distance, orientation, speed and even the types of an object in the environment around the node. Different from the technology of locating an accessed terminal in traditional communication systems, the sensing technology can realize the sensing of various information of non-accessed objects, and thus increasing the ability of the communication system to dynamically adjust the operating state (such as scheduling, beam management, early warning of the accessed terminal, etc.) according to the surrounding environment. The disclosure mainly relates to the sensing function of an integrated sensing and communication node. Without losing generality, the integrated sensing and communication node is hereinafter referred to as a sensing node, and the sensing node can be a base station, a terminal, a sidelink device and/or the like.

In sensing systems, in order to realize the sensing function, a sensing node repeatedly transmits multiple sensing signals (which can also be called “pulses”), and processes the echoes to determine whether there is a target in a certain area, and if so, estimates the characteristic information such as the distance and speed of the target, wherein the sensing signals can be physical signals and/or physical channels that can be used for sensing purposes; for example, when the sensing node is a base station, the sensing signals may be downlink reference signals or downlink physical channels; when the sensing node is a terminal, the sensing signals may be uplink reference signals or uplink physical channels. Part of the characteristic information of the target obtained from the sensing system may be used in various subsequent applications, such as target trajectory drawing or environment reconstruction. It may be seen that whether the sensing node may correctly determine whether the received signal is a target echo or interference is the first difficulty that sensing technology should overcome. When the detection target of the sensing system is a point target, the distance and velocity of the target correspond to the processing of the echo signal in two dimensions respectively, in which the target distance estimation involves the short-time processing dimension of the echo (that is, the time within the single sensing signal) and the target velocity estimation involves the long-time processing dimension of the echo (that is, the number of the sensing signals).
Several target detection algorithms proposed by the disclosure can accurately determine whether a target exists or not, and, at the same time, realize the estimation of target parameters (such as the distance between the target and the sensing node, the radial velocity of the target relative to the sensing node, and/or the like.), and have better detection and estimation performance.

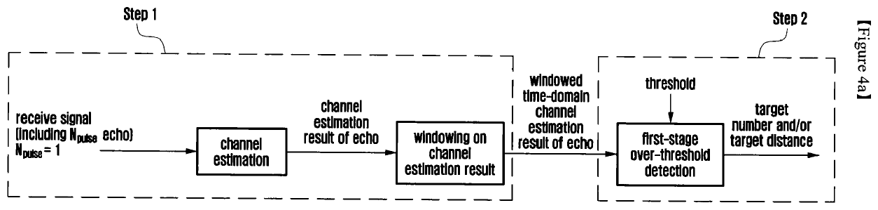

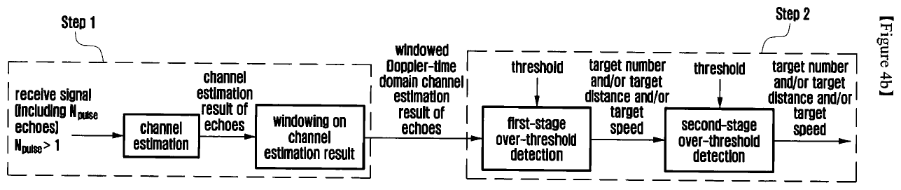

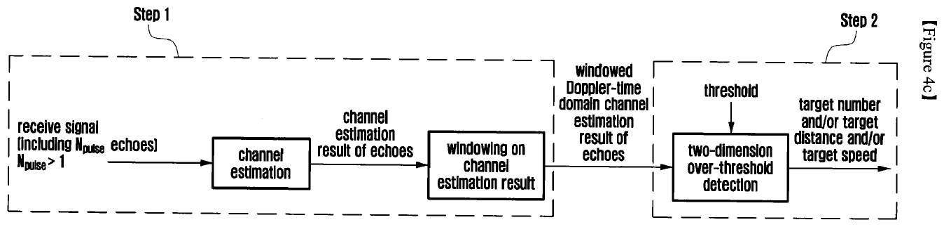

A feasible target detection method (hereinafter referred to as Method 1) receives and processes echo signals for single or multiple sensing signals transmitted by a sensing node to obtain channel estimation results, and determines the distance and/or speed of a target according to the channel estimation results. For example, the distance and speed of the target may be determined according to the channel estimation result of the single echo or multiple echoes. The flow is shown in FIGS. 4A, 4B and 4C, and the specific steps are as follows.

Step 1: the sensing node transmits a single sensing signal or multiple sensing signals to a sensing area (if a specific transmit beam is used, the specific sensing area is the coverage of the specific transmit beam), receives an echo signal of the sensing signal, performs channel estimation on the echo signal to obtain a channel estimation result of the echo, and performs windowing on the channel estimation result to obtain a windowed channel estimation result.

In one possible implementation, when the sensing node transmits a single sensing signal, the sensing node receives the time domain signal of the echo for the single sensing signal, and performs frequency domain channel estimation on a time domain signal of the single echo to obtain a frequency domain channel estimation result of the single echo; generates a window function with length N, and performs elementwise multiplication of the frequency domain channel estimation result with length N and the corresponding sample index to obtain the windowed frequency domain channel estimation result. Then the windowed frequency domain channel estimation result is subjected to IDFT/IFFT to obtain the windowed time domain channel estimation result of the single echo. Here, N is the number of sampling points of the single echo, or the maximum length of available time-domain and frequency-domain channel estimation results, and when the length of time-domain and frequency-domain channel estimation results is also N, N is also the size of DFT/FFT/IDFT/IFFT between time-domain and frequency-domain channels. In one implementation, time domain channel estimation may also be performed on the time domain signal of the single echo to obtain a time domain channel estimation result of the single echo; a window function with length N is generated, and size N DFT/FFT is performed on the window function to obtain a time domain expression of the window function with length N. The time domain channel estimation result of the single echo is convolved with the time domain expression of the window function to obtain the windowed time domain channel estimation result of the single echo.

In one implementation, when the sensing node transmits the multiple sensing signals (transmits sensing signals for many times), the sensing node stores the echo corresponding to the sensing signal transmitted for each time. One possible implementation is to store the echoes corresponding to the sensing signals transmitted for many times as a two-dimensional matrix, where each echo corresponds to one dimension of the two-dimensional matrix (a short-time processing dimension, that is, a time dimension within a single sensing signal, hereinafter referred to as a first dimension, assuming that the size of the first dimension is N, the number of sampling points corresponding to a single echo), and the transmitting times of the sensing signal are another dimension of the two-dimensional matrix (which is a long-time processing dimension, that is, the number dimension of the sensing signal, hereinafter referred to as a second dimension, assuming that the size of the second dimension is M).

In the first dimension, frequency domain channel estimation is performed on each single echo to obtain a frequency domain channel estimation result of the single echo first; a first window function with length N is generated, and multiplication (elementwise multiplication; the multiplication described below refers to multiplication of elements at the corresponding samples, and will not be described in detail later, unless it is explicitly confirmed that it is not such multiplication according to the context) of the frequency domain channel estimation result of the corresponding sample index and the first window function is performed to obtain the windowed frequency domain channel estimation result. Then the windowed frequency domain channel estimation result is subjected to IDFT/IFFT to obtain the windowed time domain channel estimation result of the single echo. Here, N is the number of sampling points of the single echo, or the length of the channel estimation result in time domain/frequency domain in the first dimension, and the size of Fourier transform/fast Fourier transform/inverse Fourier transform/inverse fast Fourier transform between the time domain and frequency domain. In one implementation, time domain channel estimation is performed on a time domain signal of the single echo to obtain a time domain channel estimation result of the single echo; a window function with length N is generated, and size N IDFT/IFFT on the window function is performed to obtain a time domain expression of the window function with length N; the time domain channel estimation result of the single echo is convolved with the time domain expression of the window function to obtain the windowed time domain channel estimation result of the single echo.

The two-dimensional matrix corresponding to the echoes is processed in the first dimension, that is, after the echo corresponding to each sensing signal is processed in the above-mentioned way, the windowed time-domain channel estimation result of the multiple echoes is obtained, where the first dimension is the time-domain channel estimation result of each echo (i.e. the short-time processing dimension), and the second dimension is the time-domain channel estimation result of the multiple echoes at corresponding sampling points (i.e. the long-time processing dimension). In the second dimension, a second window function with length M is generated, and the second dimension of the time domain channel estimation result corresponding to the sample index is multiplied by the window function to obtain the second dimension of the windowed time domain channel estimation result. Size M DFT/FFT is performed on the windowed time domain channel estimation result of the multiple echoes in the second dimension to obtain the windowed Doppler domain channel estimation result. Here, M is the number of the sensing signals transmitted by the sensing node and the maximum number of echoes that are available for the sensing node. When the sensing node uses M echoes for signal processing, M is also the size of DFT/FFT/IDFT/IFFT between the time domain and the Doppler domain of the second dimension. In one implementation, size M DFT/FFT is performed on the windowed time domain channel estimation result of the multiple echoes in the second dimension to obtain the second dimension of the Doppler domain channel estimation result. A second window function with length M is generated, and size M DFT/FFT is performed on the second window function to obtain a Doppler domain expression of the second window function. The Doppler domain channel estimation result is convolved with the Doppler domain expression of the second window function to obtain the windowed Doppler domain channel estimation result. After processing the first dimension and the second dimension of the received signals, a windowed Doppler-time domain channel estimation result of the multiple echoes is obtained.

It should be noted that each coordinate resolution unit (or referred to as index, sampling point, sample, sample point, and/or the like) of the first dimension corresponds to each sampling time in time domain, where there is a one-to-one correspondence between the sampling time and the distance between the target and the sensing node. Accordingly, each coordinate resolution unit of the second dimension corresponds to each Doppler frequency in frequency domain, where there is a one-to-one correspondence between the Doppler frequency and the radial velocity of the target relative to the sensing node.

It should be noted that in the process of obtaining the windowed channel estimation result, when the sensing node transmits multiple sensing signals, the first dimension processing and the second dimension processing of the signals do not have a sequential order, because the signal processing in the two dimensions is independent of each other. In one implementation, in the first dimension processing, the channel estimation result is the time domain channel estimation result; in the second dimension processing, the channel estimation result is the second dimension of the frequency domain channel estimation result (hereinafter the second dimension of frequency domain is referred to as Doppler domain). The advantage of this two-dimensional independent windowing design is that it is more flexible, and it can select different window functions for different dimensions according to the needs of system design.

Take an example that the sensing node transmits multiple sensing signals and performs channel estimation from frequency domain. The sensing node transmits Nₚᵤₗₛₑ sensing signals to a certain sensing area, where Nₚᵤₗₛₑ>1. The frequency domain expression of the single transmitted sensing signal is denoted as s(n),n=1, 2, . . . , N_{FFT}, and the time domain signal of the p′-th received echo is denoted as x(p′,t), where t=1, 2, . . . , N_{FFT}. For the p′-th echo, the frequency domain expression of the p′-th echo is obtained by performing size N_{FFT} discrete Fourier transform on x(p′,t), where t=1, 2, . . . , N_{FFT}. Then the frequency domain channel estimation result of the p′-th echo is h_{FD}(mp′, n)=y (p′,n)/s(n), where n=1, 2, . . . , N_{FFT}. It should be noted that the channel estimation method is not limited to the above Least Square Estimation, and other channel estimation algorithms such as Minimum Mean Square Estimation, Linear minimum mean square estimation and Maximum Likelihood Estimation are also applicable to this application. The appropriate window function w(n), where n=1, 2, . . . , N FFT, is selected to window the frequency domain channel estimation result, and the windowed frequency domain signal expression h̅_{FD}(mp′,n)=h_{FD}(mp′,n)·w(n), where n=1, 2, . . . , N_{FFT}, of the p′-th echo is obtained. In the actual windowing process, the window function may be selected and the window function parameters may be set according to the requirements of the system. The optional window function includes but is not limited to a simplified Taylor window and Kaiser window. For example, the parameters of the window function are determined according to the sidelobe attenuation of the channel estimation result of the echo signal required by the system; for another example, the echo power ratio of the nearest distance and the farthest distance in free space may be calculated according to the minimum sensing distance and the maximum sensing distance of the sensing node, and the type and the parameters of the window function may be determined accordingly. Inverse discrete Fourier transform is performed on the windowed frequency domain channel estimation result h̅_{FD}(mp′,n) of the p′-th echo to obtain the time domain channel estimation result h̅_{TD}(p′,t), where t=1, 2, . . . , N_{FFT}, of the p′-th echo. An appropriate Doppler window function w′^{(p)}, where p=1, 2, . . . , Nₚᵤₗₛₑ, is selected, and the time domain channel estimation results h_{TD}(p′,t), where t=1, 2, . . . , N_{FFT}, of all echoes corresponding to the t′-th sampling time in the second dimension are windowed to obtain the windowed channel estimation results corresponding to the t′-th sampling time in the second dimension. In the actual windowing process, the window function may be selected according to the requirements of the system. The optional window function includes but is not limited to a simplified Taylor window and Kaiser window. Then the size Nₚᵤₗₛₑ discrete Fourier transform is performed to obtain the windowed channel estimation result in time domain and Doppler domain which correspond to the t′-th sampling time at the Doppler frequency m, which is denoted as h_{DD,TD}(m,t′). That is, h_{DD,TD}(m,t) represents the corresponding windowed Doppler-time domain channel estimation result in the t′-th sampling time at the Doppler frequency m, where m=1, 2, . . . , Nₚᵤₗₛₑ, and t=1, 2, . . . , N_{FFT}.

Step 2: the sensing node performs over-threshold detection on the windowed Doppler-time domain channel estimation result to obtain an output of the number of targets, and at least one of the following estimations: the distance of the target from the sensing node and the radial velocity of the target relative to the sensing node. Among them, the distance of the target from the sensing node means the distance that sensing signal experienced from the sensing node to the target, and the radial velocity of the target relative to the sensing node means the component of the target velocity in the vertical direction of the connecting line between the target and the sensing node.

In one implementation, when the sensing node transmits the single sensing signal and receives the single echo, the sensing node performs a first-stage over-threshold detection according to the windowed time-domain channel estimation result of the single echo, where the first-stage over-threshold detection may output the number of targets and the distance of the target from the sensing node. A specific implementation of the first-stage over-threshold detection is to compare the time-domain channel estimation result obtained from the single echo with a threshold value (or alternatively referred to as a “threshold” herein, for example, a power threshold), and search for a maximum value in an area in which the power exceeds the threshold. At this time, the number of maximum values searched is the estimated number of targets, and there is a one-to-one correspondence between the resolution unit corresponding to the maximum value (that is, the sampling time) and the distance between the target and the sensing node. Therein, the area in which the threshold is exceeded refers to the resolution unit corresponding to the time domain channel estimation result whose value exceeds the power threshold, that is, the channel estimation value corresponding to the resolution unit in the area in which the power threshold is exceeded is greater than the power threshold. It should be understood that in the scene of single sensing signal, the resolution unit or coordinate resolution unit corresponds to the sampling time, and the resolution unit, coordinate resolution unit or sampling time may also be called an index, for example, an index in the first dimension. In one implementation, the power threshold may be a fixed value or a real-time calculated value or a non-real-time calculated value related to the statistical characteristic of noise; for example, the sensing node obtains the statistical characteristic such as the mean and/or variance of the noise for calculation of the power threshold, and the sensing node may obtain the noise in real time by channel estimation based on the echo signal, or set a fixed noise variance according to empirical values or theoretical values. Among them, the real-time calculated value may mean that the sensing node may estimate the noise of the echo for the sensing signal transmitted each time for the calculation of the power threshold, and the design of the real-time power threshold has the beneficial effect of improving the accuracy of the system; the non-real-time calculated value may mean that the sensing node estimates the noise of the echo for the sensing signal transmitted at a certain time, which is used for calculation of the power threshold, and uses the power threshold to detect the target in the echoes for the sensing signals transmitted several times later. The design of this non-real-time power threshold has the beneficial effects of reducing the estimation times and reducing the calculation complexity. After obtaining the statistical characteristic such as the mean and/or variance of the noise, the power threshold may be set as a function related to the statistical characteristic of the noise, for example, the power threshold is set as a linear combination of the mean and variance of the noise. The design and operation of the power threshold are simple and the calculation complexity is low.

The following gives a specific implementation method of the first-stage over-threshold detection by the sensing node according to the echo signal of the single sensing signal. Taking setting a fixed power threshold p_{Th} as an example, the number of sensing signals transmitted by the sensing node Nₚᵤₗₛₑ=1, the windowed Doppler-time domain channel estimation result h_{DD,TD}(m,t) degenerates into the time domain channel estimation result h_{TD}(t) in the first dimension, where t=1, 2, . . . , N_{FFT}. If ∀t,h_{TD}(t)≤p_{Th}, it is determined that there is no target in the sensing area; otherwise, a maximum value of h_{TD}(t) is searched at all t* that satisfy h_{TD}(t*)>p_{Th}. Assuming that N maximum values exceeding the threshold are searched from the single echo, in which the resolution unit corresponding to the i-th maximum value is denoted as t_{max,i}, the resolution unit set corresponding to the maximum value searched from the single echo is denoted as

$$𝒯 = {⋃}_{i = 1}^{N} {𝓉}_{max , i} .$$

The number of elements in the set [symbol] is the number of targets sensed from this echo, and the elements in the set [symbol] are the sampling times corresponding to each target sensed from this echo. Accordingly, the corresponding target distance at the sampling time t_{max,i} is

$$R = \frac{{𝓉}_{max , i} \cdot c}{2 \cdot {F}_{s}}$$

in meters (m), where c is the speed of light in meters per second (m/s), and Fₛ is the sampling rate in hertz (Hz).

In one possible implementation, when the sensing node transmits sensing signals for multiple times and receives multiple echoes, the sensing node successively performs two-stage over-threshold detection including first-stage over-threshold detection and second-stage over-threshold detection according to the windowed Doppler-time domain channel estimation result of the multiple echoes, where the two-stage over-threshold detection respectively processes two dimensions of the channel estimation result; when the first-stage over-threshold detection is performed on a certain dimension, the first-stage over-threshold detection outputs the initial detection result of the target number (the number of targets) of this dimension and the estimation result of the target parameter corresponding to this dimension, and when the second-stage over-threshold detection is performed on another dimension, the correction result of the target number and the estimation result of the target parameter corresponding to the other dimension are output. The correction result of the target number output by the second-stage over-threshold detection is taken as the final result of the target number. For example, when the first-stage over-threshold detection processes the first dimension of the channel estimation result and the second-stage over-threshold detection processes the second dimension of the channel estimation result, the output of the first-stage over-threshold detection is the initial detection result of the target number in the first dimension and the estimation result of the target parameter corresponding to the first dimension, that is, the distance between the target and the sensing node, and the output of the second-stage over-threshold detection is the correction result of the target number and the estimation result of the target parameter corresponding to the second dimension, that is, the radial velocity of the target relative to the sensing node. In addition, when the first-stage over-threshold detection processes the second dimension of the channel estimation result and the second-stage over-threshold detection processes the first dimension of the channel estimation result, the output of the first-stage over-threshold detection is the initial detection result of the target number in the second dimension and the estimation result of the target parameter corresponding to the second dimension, that is, the radial velocity of the target relative to the sensing node, and the output of the second-stage over-threshold detection is the correction result of the target number and the estimation result of the target parameter corresponding to the first dimension, that is, the distance of the target relative to the sensing node. It should be noted that in the two-stage over-threshold detection method, the processing of the first dimension and the second dimension of the channel estimation result is not limited in order, because the first dimension and the second dimension are independent of each other. Assuming that the length of the first dimension of the channel estimation result is K₁ and the length of the second dimension of the channel estimation result is K₂, when K₁>K₂, optionally, the first-stage over-threshold detection is performed on the first dimension of the channel estimation result, and the second-stage over-threshold detection is performed on the second dimension of the channel estimation result. When K₁<K₂, optionally, the first-stage over-threshold detection is performed on the second dimension of the channel estimation result, and the second-stage over-threshold detection is performed on the first dimension of the channel estimation result. When K₁=K₂, the first-stage over-threshold detection may be performed on the first dimension of the channel estimation result, and the second-stage over-threshold detection may be performed on the second dimension of the channel estimation result; or the first-stage over-threshold detection may be performed on the second dimension of the channel estimation result, and the second-stage over-threshold detection may be performed on the first dimension of the channel estimation result. The advantage of this two-stage over-threshold detection design is that the signal processing flow is decoupled in the first dimension and the second dimension, thereby reducing the computational complexity.

A specific implementation of the first-stage over-threshold detection is to select the channel estimation result in the first dimension or the second dimension, compare it with a power threshold, and search for a maximum value in the area in which the threshold is exceeded. At this time, the number of the maximum values searched is the initial detection result of the target number, and the resolution unit where the maximum value is located is the estimation result of the target parameter in the corresponding dimension. For example, when the first-stage over-threshold detection is performed on the first dimension of the channel estimation result, the resolution unit where the maximum value is located is the estimation result of the target parameter corresponding to the first dimension, that is, the distance between the target and the sensing node. Similarly, when the first-stage over-threshold detection is performed on the second dimension of the channel estimation result, the resolution unit where the maximum value is located is the estimation result of the target parameter corresponding to the second dimension, that is, the radial velocity of the target relative to the sensing node. In one possible implementation, the power threshold may be a fixed value or a real-time calculated value related to the statistical characteristic of noise, for example, the statistical characteristic such as variance of the noise obtained by the sensing node is used for calculation of the power threshold, and the way for the sensing node to obtain the noise may be real-time channel estimation based on the echo signals, or a fixed noise variance may be set according to empirical values or theoretical values. This design of the power threshold is simple to operate, and has low computational complexity.

In one possible implementation, a certain dimension of the channel estimation result used for comparison with the power threshold may be obtained by averaging the windowed Doppler-time domain channel estimation result in another dimension. For example, when the first-stage over-threshold detection is performed on the first dimension of the channel estimation result, the channel estimation result may be averaged in the second dimension to obtain the channel time-domain estimation result averaged in the second dimension. This design may reduce the computational complexity and improve the detection probability.

In one possible implementation, a specific implementation of the second-stage over-threshold detection is to compare the channel estimation result in the unprocessed dimension in the first-stage over-threshold detection with the power threshold, and search for a maximum value in the area in which the threshold is exceeded, where the number of maximum values searched is the correction result of the target number, and the resolution unit where the maximum value is located is the estimation result of the target parameter in the corresponding dimension. For example, when the second-stage over-threshold detection is performed on the first dimension of the channel estimation result, the resolution unit where the maximum value is located is the estimation result of the target parameter corresponding to the first dimension, that is, the distance of the target from the sensing node. Similarly, when the second-stage over-threshold detection is performed on the second dimension of the channel estimation result, the resolution unit where the maximum value is located is the estimation result of the target parameter corresponding to the second dimension, that is, the radial velocity of the target relative to the sensing node. In one possible implementation, the power threshold may be a fixed value or a real-time or non-real-time calculated value related to the statistical characteristic of noise, for example, the sensing node obtains the statistical characteristic such as variance of the noise for calculation of the power threshold, and the sensing node may obtain the noise in real time by channel estimation based on the echo signals, or set a fixed variance of the noise according to empirical values or theoretical values. Among them, the real-time calculated value may mean that the sensing node may estimate the noise of the echo for the sensing signal transmitted each time for calculation of the power threshold, and the design of the real-time power threshold has the beneficial effect of improving the accuracy of the system; the non-real-time calculated value may mean that the sensing node estimates the noise of the echo for the sensing signal transmitted at a certain time, which is used for calculation of the power threshold, and the power threshold is used to detect the target in the echo for the sensing signal transmitted several times later. The design of this non-real-time power threshold has the beneficial effects of reducing the estimation times and reducing the calculation complexity.

In one possible implementation, the power threshold for the first-stage over-threshold detection may be the same as or different from the power threshold for the second-stage over-threshold detection.

In one possible implementation, a certain dimension of the channel estimation result used for comparison with the power threshold may be obtained by, according to the resolution unit corresponding to the maximum value in the dimension where the first-stage over-threshold detection processing is performed, extracting another dimension of the channel estimation result corresponding to the resolution unit from the windowed Doppler-time domain channel estimation result. This design may reduce the number of input data in the second-stage over-threshold detection, thereby reducing the computational complexity. For example, when the second-stage over-threshold detection is performed on the first dimension of the channel estimation result, according to the resolution unit corresponding to the maximum value in the dimension (second dimension) where the first-stage over-threshold detection processing is performed, the first dimension of the time-domain channel estimation result corresponding to the resolution unit may be extracted from the windowed Doppler-time-domain channel estimation result for the second-stage over-threshold detection. Similarly, when the second-stage over-threshold detection is performed on the second dimension of the channel estimation result, according to the resolution unit corresponding to the maximum value in the dimension (the first dimension) where the first-stage over-threshold detection processing is performed, the second dimension of the Doppler domain channel estimation result corresponding to the resolution unit may be extracted from the windowed Doppler-time domain channel estimation result for the second-stage over-threshold detection.

The following gives an example implementation method of two-stage over-threshold detection by the sensing node according to echo signals for multiple sensing signals. For example, the first-stage over-threshold detection processes the first dimension of the channel estimation result, and the second-stage over-threshold detection processes the second dimension of the channel estimation result. In one implementation, the first-stage over-threshold detection is performed on the Doppler-time domain channel estimation obtained in step 1. Taking setting a fixed power threshold p_{Th} as an example, h_{DD,TD}(m,t) is averaged in time domain first, and in one implementation, the corresponding h_{DD,TD}(m′, t) at different Doppler frequency m′ is averaged to obtain the time domain channel estimation result, denoted as

$${\tilde{h}}_{D D , T D} ( t ) = \frac{1}{{N}_{pulse}} {\sum }_{m = 1}^{{N}_{pulse}} {h}_{D D , T D} ( m , t ) , t = 1 , 2 , … , {N}_{F F T} .$$

If ∀t,h̅_{DD,TD}(t)≤p_{Th}, it is determined that there is no target in the sensing area; otherwise, a maximum value of h̅_{DD,TD}(t) is searched at all t* that satisfy h̅_{DD,TD}(t*)>p_{Th}. Assume that N maximum values are searched from h̅_{DD,TD}(t), where the position of the i-th maximum value is denoted as t_{max,i}, and the set of maximum value positions is denoted as

$$𝒯 = {⋃}_{i = 1}^{N} {t}_{max , i} .$$

The number of elements in the set is the number of targets sensed at this time, and the elements in the set [symbol] are the sampling times corresponding to each target. Accordingly, the corresponding target distance at the sampling time t_{max,i} is

$$R = \frac{{t}_{max , i} \cdot c}{2 \cdot {F}_{s}}$$

m, where c is the speed of light in m/s, and Fₛ is the sampling rate in Hz. Then, the second-stage over-threshold detection is performed on the Doppler-time domain channel estimation obtained in step 1. Taking setting a fixed power threshold as an example, according to the sampling time set estimated in the first-stage over-threshold detection, the Doppler domain of the channel estimation result corresponding to the elements in the sampling time set [symbol] is extracted from h_{DD,TD}(m,t). In one implementation, for any tₘₐₓ∈ [symbol] , the Doppler domain of the channel estimation result h_{DD,TD}(m,tₘₐₓ),m=1, 2, . . . , Nₚᵤₗₛₑ corresponding to the sampling time is obtained. If ∀m,h_{DD,TD}(m,tₘₐₓ)≤p_{Th}, it is determined that there is no target in the distance corresponding to the sampling time; otherwise, a maximum value of h_{DD,TD}(m*, tₘₐₓ) is searched at all m* that satisfy h_{DD,TD}(m*, tₘₐₓ)>p_{Th}. Assuming that N maximum values are searched from h_{DD,TD}(m,tₘₐₓ), and the position of the i-th maximum value is denoted as m_{max,i}, then the set of maximum value positions at the sampling time tₘₐₓ is denoted as

$${ℳ}_{{t}_{max}} = {⋃}_{i = 1}^{N} {m}_{m a x , i} .$$

The number of elements in the set [symbol] is the number of targets corresponding to the sampling time tₘₐₓ, and the elements in the set [symbol] are the radial velocity of the target relative to the sensing node corresponding to the sampling time tₘₐₓ. Accordingly, the target speed at the Doppler frequency m_{max,i} is

$$\frac{- ( {m}_{max , i} - \frac{{N}_{pulse}}{2} - 1 ) \cdot PRF \cdot λ}{2 \cdot {N}_{p u l s e}} m / s ,$$

where PRF is the repetition frequency of the sensing signal in Hz and λ is the wavelength of the sensing signal in m (meter).

In one possible implementation, when the sensing node transmits multiple sensing signals and receives multiple echoes, in addition to the above-mentioned method of detecting the first dimension and the second dimension separately, as another implementation of detection method for estimating the number, distance and/or radial velocity of targets, the sensing node may also perform two-dimensional joint over-threshold detection according to the windowed Doppler-time domain channel estimation results of multiple echoes. Among them, the two-dimensional joint over-threshold detection may output one or more of target number detection results and target parameters, where the target parameters include the distance of the target from the sensing node and/or the radial velocity of the target relative to the sensing node.

An example implementation of the two-dimensional joint over-threshold detection is to compare the windowed Doppler-time domain channel estimation result with a power threshold, and search for a maximum value in the area in which the threshold is exceeded to obtain a two-dimensional index set corresponding to one or more maximum values. At this time, the number of maximum values searched or the number of index pairs in the two-dimensional index set is the estimated number of targets. The resolution unit of the first dimension (the index corresponding to the first dimension in the index pair, that is, the sampling time) of the maximum value corresponds to the distance between the target and the sensing node, and the coordinate of the second dimension (the index corresponding to the second dimension in the index pair, that is, the Doppler frequency) of the maximum value corresponds to the radial velocity of the target relative to the sensing node. This design of two-dimensional joint over-threshold detection can improve the detection accuracy of the existence of the target. Because of the joint processing and maximum search of the first dimension and the second dimension of the channel estimation result, the maximum value output is both the maximum value for the first dimension and the maximum value for the second dimension. The power threshold may be a fixed value or a real-time or non-real-time calculated value related to the statistical characteristic of noise. For example, the sensing node obtains the statistical characteristic such as variance of the noise for calculation of the power threshold, and the sensing node may obtain the noise in real time by channel estimation based on the echo signals, or set a fixed noise variance according to empirical values or theoretical values. Among them, the real-time calculated value may mean that the sensing node may estimate the noise of the echo for the sensing signal transmitted each time for calculation of the power threshold, and the design of the real-time power threshold has the beneficial effect of improving the accuracy of the system; the non-real-time calculated value may mean that the sensing node estimates the noise of the echo for a sensing signal transmitted at a certain time, which is used for calculation of the power threshold, and the power threshold is used to detect the target in the echo for the sensing signal transmitted several times later. The design of this non-real-time power threshold has the beneficial effects of reducing the estimation times and reducing the calculation complexity.

An example implementation method of two-dimensional joint over-threshold detection by the sensing node according to echo signals for multiple sensing signals is given below. Taking setting a fixed power threshold p_{Th} as an example, considering the channel estimation result h_{DD,TD}(m,t) in Doppler domain and time domain, if ∀t,∀m,h_{DD,TD}(m,t)≤p_{Th}, it is determined that there is no target in the sensing area; otherwise, a maximum value of h_{DD,TD}(m,t) is searched at all (m*, t*) that satisfy h_{DD,TD}(m*, t*)>p_{Th}. Assuming that N maximum values are searched, in which the position of the i-th maximum value is denoted as (m_{max,i}, t_{max,i}), and the set of maximum value positions is denoted

$$𝒯 = {⋃}_{i = 1}^{N} ( {m}_{max , i} , {t}_{max , i} ) .$$

The number of elements (that is, index pairs) in the set [symbol] is the number of targets sensed at this time, and the elements in the set [symbol] are the Doppler frequency and time domain sampling time corresponding to each target. Accordingly, the target speed at the Doppler frequency m_{max,i} is

$$\frac{- ( {m}_{max , i} - \frac{{N}_{pulse}}{2} - 1 ) \cdot PRF \cdot λ}{2 \cdot {N}_{p u l s e}} m / s ,$$

where PRF is the repetition frequency of the sensing signal in Hz and λ is the wavelength of the sensing signal in m. The corresponding target distance at the sampling time t_{max,i} is

$$R = \frac{{t}_{max , i} \cdot c}{2 \cdot {F}_{s}} m ,$$

where c is the speed of light in m/s and Fₛ is the sampling rate in Hz.

The first method mentioned above has the advantages of simple implementation and low complexity, and is suitable for single target recognition in simple scenes, such as recognition of point targets.

Consider a more complex integrated sensing and communication scenario, in which the cross-sectional area of a target (for example, radar cross-sectional area, which will be described as an example below) and the distance between the target and a sensing node are randomly distributed, and high radar cross-sectional area or too close to the sensing node will lead to the increasement of the target echo power. Among them, the radar cross-sectional area of the target is a physical quantity to measure the electromagnetic wave power returned by the original path after the radar wave irradiates the target. The larger the radar cross-sectional area of the target, the higher the power of the corresponding echo received by the sensing node.

When there are multiple targets in a certain sensing area (for example, within the coverage of a certain transmit beam), the echo power of target A located in close proximity and/or with high radar cross-sectional area is too large, and its sidelobe will drown the main lobe of the echo for target B located farther away and/or with lower radar cross-sectional area, resulting in the failure of detecting target B, that is, miss detection occurs in the system. In order to solve the above problems, this patent also proposes the following target detection algorithm, which performs filtering, over-threshold detection and maximum search on channel estimation results. This method can improve the judgment accuracy of the system on the existence of the target, while realizing the estimation of the distance and/or speed of the target in the sensing system.

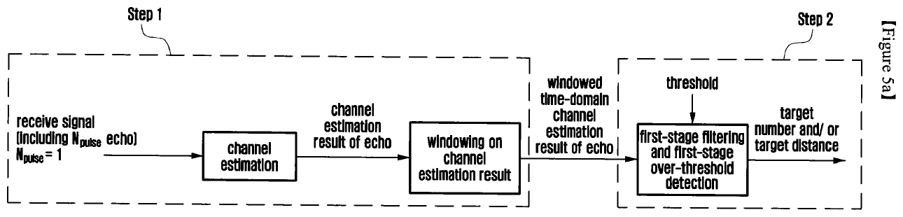

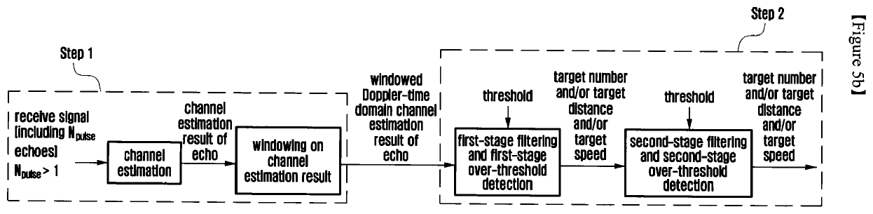

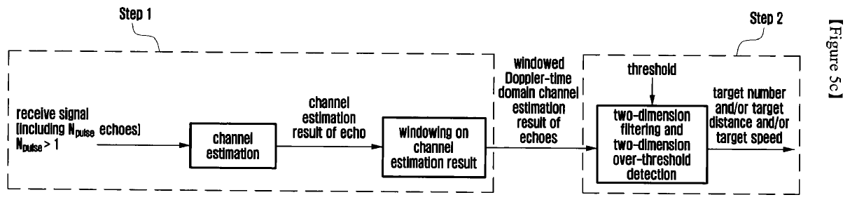

Another feasible target detection method (hereinafter referred to as Method 2) adds a filtering step on the basis of Method 1, and receives and processes echo signals for single or multiple sensing signals transmitted by a sensing node to obtain channel estimation results, and determines the distance and/or speed of the target according to the channel estimation results. For example, the number of targets and the distance between the target and the sensing nodes may be determined according to the channel estimation result of the single echo in time domain, or may be determined according to the Doppler-time domain channel estimation result of the multiple echoes. The flow is shown in FIG. 5A, FIG. 5B and FIG. 5C, and the specific steps are as follows.

Step 1: the sensing node transmits a single or multiple sensing signals to a specific sensing area (if a specific transmit beam is used, the specific sensing area is the coverage of the specific transmit beam), receives an echo signal of the sensing signal, performs channel estimation on the echo signal to obtain a channel estimation result of the echo, and performs windowing on the channel estimation result to obtain a windowed channel estimation result.

In one possible implementation, when the sensing node transmits the single sensing signal, the sensing node receives the time domain signal of the echo for the single sensing signal, and performs frequency domain channel estimation on the time domain signal of the single echo to obtain the frequency domain channel estimation result of the single echo. A window function with length N is generated, and the frequency domain channel estimation result corresponding to the sample index is multiplied by the window function to obtain the windowed frequency domain channel estimation result. Then the windowed frequency domain channel estimation result is subjected to IDFT/IFFT to obtain the windowed time domain channel estimation results of the single echo. Here, N is the number of sampling points of the single echo, or the length of channel estimation result in time domain/frequency domain, and the size of DFT/FFT/IDFT/IFFT between the time domain and frequency domain. In one possible implementation, the time domain channel estimation is performed on the time domain signal of the single echo to obtain the time domain channel estimation result of the single echo. A window function with length N is generated, and the time domain expression of the window function with length N is obtained by performing size N IDFT/IFFT on the window function. The time domain channel estimation result of the single echo is convolved with the time domain expression of the window function to obtain the windowed time domain channel estimation result of the single echo.

In one possible implementation, when the sensing node transmits the sensing signals for multiple times, the echoes are stored as a two-dimensional matrix first, where each echo corresponds to one dimension of the two-dimensional matrix (short-time processing dimension, that is, the time dimension within a single sensing signal, hereinafter referred to as the first dimension), and the number of sensing signals is another dimension of the two-dimensional matrix (long-time processing dimension, that is, the number dimension of sensing signals, hereinafter referred to as the second dimension). First, in the first dimension, the frequency domain channel estimation of each echo is performed to obtain the frequency domain channel estimation result of each echo. A first window function with length N is generated, and the frequency domain channel estimation result corresponding to the sample index is multiplied by the first window function to obtain the windowed frequency domain channel estimation result. Then the windowed frequency domain channel estimation result is subjected to IDFT/IFFT to obtain the windowed time domain channel estimation result of the single echo. Here, N is the number of sampling points of the single echo, or the length of channel estimation result in time domain/frequency domain, and the size of DFT/FFT/IDFT/IFFT between the time domain and frequency domain.

In one possible implementation, time domain channel estimation is performed on the time domain signal of each echo to obtain the time domain channel estimation result of each echo. A window function with length N is generated, and the time domain expression of the window function with length N is obtained by performing size N IDFT/IFFT on the window function. The time domain channel estimation result of each echo is convolved with the time domain expression of the window function to obtain the windowed time domain channel estimation result of each echo. After each echo is processed by the above-mentioned first dimension processing, the time domain channel estimation results after multiple echo windowing are obtained. In the second dimension, a second window function with length M is generated, and the second dimension of the time domain channel estimation result corresponding to the sample index is multiplied by the window function to obtain the second dimension of the windowed time domain channel estimation result. Then size M DFT/FFT is performed on the second dimension of the windowed time domain channel estimation result to obtain the windowed Doppler domain channel estimation result. Here, M is the number of sensing signals transmitted by the sensing node, or the size of DFT/FFT/inverse Fourier transform/inverse fast Fourier transform between time domain and Doppler domain of the second dimension.

In one possible implementation, size M DFT/FFT is performed on the windowed time domain channel estimation result of the multiple echoes in the second dimension to obtain the second dimension of the Doppler domain channel estimation result. A second window function with length M is generated, and size M DFT/FFT is performed on the second window function to obtain the Doppler domain expression of the second window function. The Doppler domain channel estimation result is convolved with the Doppler domain expression of the second window function to obtain the windowed Doppler domain channel estimation result. After processing the first dimension and the second dimension of the received signals, the windowed Doppler-time domain channel estimation result of the multiple echoes is obtained.

In embodiments of the application, in the process of obtaining the windowed channel estimation result, when the sensing node transmits multiple sensing signals, the first dimension processing and the second dimension processing of the echo signals for the sensing signals are not limited in order, and the signal processing in the two dimensions are independent of each other. In one possible implementation, in the first dimension processing, the channel estimation result is the time domain channel estimation result; in the second dimension processing, the channel estimation result is the second dimension of the frequency domain channel estimation result (hereinafter, the second dimension of frequency domain is referred to as Doppler domain). This design with independent windowing of two dimensions is more flexible, and it can select different window functions for different dimensions according to the needs of system design.

Step 2: the sensing node performs filtering and over-threshold detection on the windowed Doppler-time domain channel estimation result, outputs the number of targets, and obtains at least one or more of the following estimations: the distance of the target from the sensing node and the radial velocity of the target relative to the sensing node. Among them, the distance of the target from the sensing node means the distance that the sensing signal travels from the sensing node to the target, and the radial velocity of the target relative to the sensing node means the component of the target velocity in the vertical direction of the connecting line between the target and the sensing node.

When the sensing node transmits a single sensing signal and receives a single echo, the sensing node performs first-stage filtering processing and first-stage over-threshold detection according to the windowed time domain channel estimation result of the single echo, where the first-stage filtering processing may output the number of targets and the distance of the target from the sensing node. A specific implementation of the first-stage filtering process is to generate a filter with length L₁, convolve the time-domain channel estimation result with the above filter to obtain the convolved time-domain channel estimation result, and take the difference between the corresponding samples of the time-domain channel estimation result and the convolved time-domain channel estimation result to obtain the first-stage channel power difference. In one implementation, in the process of filtering the time domain channel estimation result, different filters may be used to process the same time domain channel estimation result, wherein the different filters may be the same type of filters with different lengths, different types of filters with the same length, or different types of filters with different lengths. The design advantage of using different filters to process the same time domain estimation result is that filters may be designed for targets with different radar cross-sectional areas, and the detection performance may be optimized in the scene where the distribution of target radar cross-sectional areas is random.

In one implementation, the determination of filter length is related to the scene where the sensing node is located and the expectation of system detection performance. Taking the radar cross-sectional area distribution of the target type expected to be detected by the sensing system and the filter length as examples, the relationship between the expectation of system detection performance and the setting of filter length is explained below. Without losing generality, this correlation may be extended to the scene where the sensing node is located and the setting of filter length. An example of this correlation may be that when the radar cross-sectional area range of the target that the sensing node expects to detect is smaller (denoted as [a₁, b₁]), the length of the filter is c₁, and when the radar cross-sectional area range of the target that the sensing node expects to detect is larger (denoted as [a₂, b₂]), the length of the filter is c₂. Here, c₁ and c₂ may be set to any real number, and optionally, may be set to any odd number. When the filter length is set to an odd number, the following beneficial effects may be obtained: the filtered result may better retain the characteristics of the sampling points before filtering. Optionally, when b₁−a₁<b₂−a₂, c₁>c₂. Furthermore, the length L₁ of a shorter filter may be set to odd numbers such as 7, 9, 11, etc, the length L₁ of a medium filter may be set to 21, 31, 41, etc, and the length L₁ of a longer filter may be set to 119, 129, etc. It should be noted that the length of the filter cannot exceed the length of data. For example, when filtering the channel estimation result in time domain, the length of the filter cannot exceed the sampling points of the channel estimation result of the single sensing signal.

A specific implementation of the first-stage over-threshold detection is to compare the first-stage channel power difference with a first-stage power difference threshold, and a maximum value is searched in the area in which the threshold is exceeded. At this time, the number of maximum values searched is the estimated number of targets, and there is a one-to-one correspondence between the resolution unit where the maximum value is located (that is, the sampling time) and the distance between the target and the sensing node.

In one implementation, the first-stage power difference threshold may be a fixed value or a real-time calculated value related to the statistical characteristic of noise, for example, the statistical characteristic such as variance of the noise obtained by the sensing node is used for calculation of the power difference threshold. In one implementation, for example, after the sensing node obtains the statistical characteristic such as variance of the noise, Monte Carlo method is used to generate multiple simulations of random noise (denoted as first-stage noise). The same filtering as that of the channel estimation result is performed on the first-stage noise, the difference of the corresponding samples of the first-stage noise and its filtered first-stage noise is taken, and the maximum value of the difference is selected to obtain the first-stage power difference threshold. Optionally, in the process of calculating the first-stage power difference threshold, a typical value may be added on the basis of the difference obtained by taking the difference between the corresponding samples of the first-stage noise and its filtered first-stage noise. In one possible implementation, the determination of the typical value T is related to the length of the filter. An example of this correlation may be that when the filter length is c₂, the aforementioned typical value is t₁, and when the filter length is c₂, the aforementioned typical value is t₂. Optionally, when c₁>c₂, t₁<t₂, that is, the smaller the length of the filter, the larger the typical value should be set, so as to prevent the power spike generated by random noise from being determined as the target. Optionally, when the filter length is greater than a certain value (denoted as c₃), the above-mentioned typical value is t₃, thereby improving the accuracy of judging whether the target exists or not. For example, when the filter length is greater than 119, the aforementioned typical value is 0.

The following gives the specific implementation method of filtering and first-stage over-threshold detection by the sensing node according to the echo signal of the single sensing signal. Taking moving average filtering as an example, the time domain estimation result h_{TD}(t), t=1, 2, . . . , N_{FFT} of the channel is filtered several times. Assuming that the number of times of moving average filtering is N_{MAF}, in one implementation, in the k-th moving average filtering operation, the length of the moving average filter is set to Qₖ, where the parameter may be an arbitrary odd number greater than 1, which is a preset parameter. The k-th moving average filtering is performed on h_{TD}(t) to obtain h_{TD,MAF,k}(t).

In one implementation, when

$$1 \leq t \leq \frac{{Q}_{k} - 1}{2} , {h}_{TD , MAF , k} ( t ) = \frac{1}{2 t - 1} {\sum }_{i = 1}^{2 t - 1} {h}_{T D} ( i ) ;$$

$$when \frac{{Q}_{k} - 1}{2} < t \leq {N}_{F F T} - \frac{{Q}_{k} - 1}{2} , {h}_{TD , MAF , k} ( t ) = \frac{1}{{Q}_{k}} {\sum }_{i = t - \frac{{Q}_{k} - 1}{2}}^{t + \frac{{Q}_{k} - 1}{2}} {h}_{T D} ( i ) ;$$

$$when {N}_{F F T} - \frac{{Q}_{k} - 1}{2} < t \leq {N}_{F F T} ,$$

$${h}_{TD , MAF , k} ( t ) = \frac{1}{2 ( {N}_{F F T} - t ) + 1} {\sum }_{i = 2 t - {N}_{F F T}}^{{N}_{F F T}} {h}_{T D} ( i ) .$$

The difference between h_{TD}(t) and h_{TD,MAF,k}(t) is calculated, and denoted as h_{TD,diff,k}(t)=h_{TD}(t)−h_{TD, MAF,k}(t), t=1, 2, . . . , N_{FFT}.

In one implementation, the k-th cyclic moving average filtering is performed on h_{TD}(t) to obtain h_{TD,CMAF,k}(t) when

$$1 \leq t \leq \frac{{Q}_{k} - 1}{2} ,$$

$${h}_{TD , CMAF , k} ( t ) = \frac{1}{{Q}_{k}} ( {\sum }_{i = 1}^{t + \frac{{Q}_{k} - 1}{2}} {h}_{T D} ( i ) + {\sum }_{i = t + {N}_{FFT} - \frac{{Q}_{k} - 1}{2} + 2}^{{N}_{F F T}} {h}_{T D} ( i ) ) ;$$

$$when \frac{{Q}_{k} - 1}{2} < t \leq {N}_{FFT} - \frac{{Q}_{k} - 1}{2} , {h}_{TD , CMAF , k} ( t ) = \frac{1}{{Q}_{k}} {\sum }_{i = t - \frac{{Q}_{k} - 1}{2}}^{t + \frac{{Q}_{k} - 1}{2}} {h}_{T D} ( i ) ;$$

$$when {N}_{FFT} - \frac{{Q}_{k} - 1}{2} < t \leq {N}_{FFT} ,$$

$${h}_{T D , C M A F , k} ( t ) = \frac{1}{{Q}_{k}} ( {\sum }_{i = 1}^{t - {N}_{FFT} + \frac{{Q}_{k} - 1}{2} + 1} {h}_{T D} ( i ) + {\sum }_{i = t - \frac{{Q}_{k} - 1}{2}}^{{N}_{F F T}} {h}_{T D} ( i ) ) .$$

The difference between h_{TD}(t) and h_{TD,MAF,k}(t) is calculated, denoted as h_{TD,diff,k}(t)=h_{TD}(t)−h_{TD,CMAF,k}(t), t=1, 2, . . . , N_{FFT}. Then, by modeling the noise, the statistical characteristic of the noise is extracted to calculate the power difference threshold.

In one implementation, the sensing node estimates the variance of the noise, and generates a noise vector with the corresponding variance by using a simulation method, which is denoted as n₁(mt), t=1, 2, . . . , N_{FFT}. Fourier transform is performed on n₁(mt) and windowing with w(n) is performed in frequency domain, and then the time domain noise n̅₁(t), t=1, 2, . . . , N_{FFT} windowed in frequency domain is obtained by inverse Fourier transform. n̅₁(t) is processed by using a moving average filter or a cyclic moving average filter with length Qₖ, and the processing result is denoted as n₂(t). It should be noted that the filter length of the k-th moving average filtering of the noise needs to be the same as that of the k-th moving average filtering of the echo to be processed. The difference between n̅₁(t) and n₂(t) is calculated,

$${P}_{Th , k} = {max}_{t} ( {n}_{diff , k} ( t ) )$$

is set as the threshold corresponding to the filter with length Qₖ. In actual reception, the sensing node may generate multiple pieces of noise through simulation and process them separately, and take the maximum value of the multiple

$${max}_{t} ( {n}_{diff , k} ( t ) )$$

obtained after the k-th moving average filtering as the threshold. In addition, when the window length is smaller, in order to prevent the random spike in noise from being determined as the target, when setting the threshold, the typical value may be added to

$${max}_{t} ( {n}_{diff , k} ( t ) )$$

as the threshold, that is

$${P}_{Th , k} = {max}_{t} ( {n}_{diff , k} ( t ) ) + Δ p .$$

For example, to the smaller the window length is, the larger the typical value should be set. If ∀t,h_{TD,diff,k}(t)≤p_{Th,k}, it is determined that there is no target in the sensing area; otherwise, a maximum value of h_{TD,diff,k}(t) is searched at all t* that satisfy h_{TD,diff,k}(t)>p_{Th,k}. Assuming that Nₖ maximum values are searched in the k-th moving average filtering of the single echo, in which the position of the i-th maximum value is denoted as t_{max,k,i}, and the set of maximum value positions searched after the k-th moving average filtering of the single echo is denoted as

$${𝒯}_{k} = {⋃}_{i = 1}^{{N}_{k}} {t}_{max , k , i} .$$

Take the union of the N_{MAF} moving average results to obtain the set of maximum value positions

$$𝒯 = {⋃}_{i = 1}^{{N}_{MAF}} {𝒯}_{i} .$$

The number of elements in the set [symbol] is the number of sensed targets, and the elements in the set [symbol] are the time domain sampling times corresponding to each target. Accordingly, the corresponding target distance at the sampling time t_{max,k,i} is

$$R = \frac{{t}_{max , k , i} \cdot c}{2 \cdot {F}_{s}} m ,$$

where c is the speed of light in m/s and Fₛ is the sampling rate in Hz.

In one implementation, when the sensing node transmits the multiple sensing signals and receives the multiple echoes, the sensing node successively performs two-stage filtering and over-threshold detection according to the windowed Doppler-time domain channel estimation results of the multiple echoes. In one implementation, two-stage filtering and over-threshold detection include first-stage filtering processing and first-stage over-threshold detection, and second-stage filtering processing and second-stage over-threshold detection. Among them, the first-stage filtering processing and the first-stage over-threshold detection may process a certain dimension of the channel estimation result, which is used to output the initial detection result of the target number and the estimation result of the target parameter corresponding to this dimension, and the second-stage filtering processing and the second-stage over-threshold detection process another dimension of the channel estimation result, and output the correction result of the target number and the estimation result of the target parameter corresponding to the other dimension. The correction result of the target number is taken as the final result of the target number.

For example, when the first-stage filtering processing and the first-stage over-threshold detection process the first dimension of the channel estimation result, and the second-stage filtering processing and the second-stage over-threshold detection process the second dimension of the channel estimation result, the output of the first-stage over-threshold detection is the initial detection result of the target number in the first dimension and the estimation result of the target parameter corresponding to the first dimension, that is, the distance between the target and the sensing node, and the output of the second-stage over-threshold detection is the correction result of the target number and the estimation result of the target parameter corresponding to the second dimension, that is the radial velocity of the target relative to the sensing node. For another example, when the first-stage filtering processing and the first-stage over-threshold detection process the second dimension of the channel estimation result, and the second-stage filtering processing and the second-stage over-threshold detection process the first dimension of the channel estimation result, the output of the first-stage over-threshold detection is the initial detection result of the target number in the second dimension and the estimation result of the target parameter corresponding to the second dimension, that is, the radial velocity of the target relative to the sensing node, and the output of the second-stage over-threshold detection is the correction result of the target number and the estimation result of the target parameter corresponding to the first dimension. In the two-stage over-threshold detection method of the embodiments of the application, the processing of the first dimension and the second dimension of the channel estimation result is not limited in order, and the first dimension and the second dimension are independent of each other. Assuming that the length of the first dimension of the channel estimation result is K₁, and the length of the second dimension of the channel estimation result is K₂, when K₁>K₂, optionally, the first-stage filtering processing and the first-stage over-threshold detection are performed on the first dimension of the channel estimation result, and the second-stage filtering processing and the second-stage over-threshold detection are performed on the second dimension of the channel estimation result. When K₁<K₂, optionally, the first-stage over-threshold detection is performed on the second dimension of the channel estimation result, and the second-stage over-threshold detection is performed on the first dimension of the channel estimation result. The advantage of this two-stage over-threshold detection design is to reduce the computational complexity.

An exemplary implementation of the first-stage filtering processing is to generate a first filter with length M₁, select the channel estimation result in the first dimension or the second dimension, convolve with the first filter to obtain the filtered channel estimation result, and take the difference of the corresponding samples of the channel estimation result in this dimension and the filtered channel estimation result to obtain a first-stage channel power difference. In one implementation, when filtering the channel estimation result of this dimension, different filters may be used to process the same channel estimation result, where the different filters may be the same type of filters with different lengths, different types of filters with the same length, or different types of filters with different lengths. The design advantage of using different filters to process the same channel estimation result is that filters may be designed for targets with different radar cross-sectional areas, and the detection performance may be optimized in the scene where the distribution of target radar cross-sectional areas is random.

In one implementation, the determination of filter length is related to the scene where the sensing node is located and the expectation of system detection performance. Taking the radar cross-sectional area distribution of the target type expected to be detected by the sensing system and the filter length as examples, the relationship between the expectation of system detection performance and the setting of filter length is explained below. Without losing generality, this correlation may be extended to the scene where the sensing node is located and the setting of filter length. An example of this correlation may be that when the radar cross-sectional area range of the target that the sensing node expects to detect is smaller (denoted as [a₁, b₁]), the length of the filter is c₁, and when the radar cross-sectional area range of the target that the sensing node expects to detect is larger (denoted as [a₂, b₂]), the length of the filter is c₂. Here, c₁ and c₂ may be set to any real number, and optionally, may be set to any odd number. When the filter length is set to an odd number, the following beneficial effects may be obtained: the filtered result may better retain the characteristics of the sampling points before filtering. Optionally, when b₁−a₁<b₂−a₂, c₁>c₂. Furthermore, the length M₁ of a shorter filter may be set to odd numbers such as 7, 9, 11, etc, the length M₁ of a medium filter may be set to 21, 31, 41, etc, and the length M₁ of a longer filter may be set to 119, 129, etc. The advantages of setting filters with different lengths are that the filter with smaller length can improve the detection probability of targets with similar distance but different echo powers, while the filter with larger length can improve the detection probability of targets with similar distance but similar echo powers. It should be noted that the length of the filter cannot exceed the length of the data. For example, when filtering the first dimension of the channel estimation result, the length of the filter cannot exceed the number of sampling points of the channel estimation result of a single sensing signal. Similarly, when filtering the second dimension of the channel estimation result, the length of the filter cannot exceed the number of received sensing signals. And, the channel estimation result of a certain dimension used for convolution with the filter may be that the windowed Doppler-time domain channel estimation result is averaged in another dimension. For example, when the first-stage filtering processing is performed on the first dimension of the channel estimation result, the channel estimation result may be averaged in the second dimension to obtain the first dimension of the channel estimation result averaged in the second dimension. The advantage of this design is to reduce the computational complexity and improve the detection probability.

An example implementation of the first-stage over-threshold detection is to compare the first-stage channel power difference with the first-stage power difference threshold, and a maximum value is searched in the area in which the threshold is exceeded. At this time, the number of maximum values searched is the initial detection result of the target number, and the resolution unit where the maximum value is located is the estimation result of the target parameter in the corresponding dimension. In one implementation, the first-stage power difference threshold may be a fixed value or a real-time calculated value related to the statistical characteristic of noise, for example, the statistical characteristic such as variance of the noise obtained by the sensing node is used for calculation of the power difference threshold. In one implementation, for example, after the sensing node obtains the statistical characteristic such as variance of the noise, Monte Carlo method is used to generate multiple simulations of random noise (referred to as first-stage noise). The same filtering as that of the channel estimation result is performed on the first-stage noise, the difference of the corresponding samples of the first-stage noise and its filtered first-stage noise is taken, and the maximum value of the difference is selected to obtain the first-stage power difference threshold.

Optionally, in the process of calculating the first-stage power difference threshold, a typical value T₁ may be added on the basis of the difference obtained by taking the difference of the corresponding samples of the first-stage noise and the filtered first-stage noise. In one implementation, the determination of the typical value T₁ is related to the length of the filter. An example of this correlation may be that when the filter length is c₁, the aforementioned typical value is t₁, and when the filter length is c₂, the aforementioned typical value is t₂. Optionally, when c₁>c₂, t₁<t₂, that is, the smaller the length of the filter, the larger the typical value should be set, so as to prevent the power spike generated by random noise from being determined as the target. Optionally, when the filter length is greater than a certain value (denoted as c₃), the above-mentioned typical value is t₃, thereby improving the accuracy of judging whether the target exists or not. For example, when the filter length is greater than 119, the aforementioned typical value is 0. This power difference threshold improves the accuracy of judging whether the target exists or not and/or the like.

A specific implementation of the second-stage filtering processing is to generate a second filter with length M₂, convolve the channel estimation result in the unprocessed dimension in the first-stage over-threshold detection with the second filter to obtain a filtered channel estimation result, and take the difference of the corresponding samples of the channel estimation result in this dimension and the filtered channel estimation result to obtain the second-stage channel power difference. In one implementation, when filtering the channel estimation result of this dimension, different filters may be used to process the same channel estimation result, where the different filters may be the same type of filters with different lengths, different types of filters with the same length, or different types of filters with different lengths. This design, which uses different filters to process the same channel estimation result, may design filters for targets with different radar cross-sectional areas, and optimize the detection performance in scenes with random distribution of target radar cross-sectional areas.

The setting method of the length of the second filter is similar to the setting method of the length of the first filter described above, and will not be repeated here.

In one implementation, the channel estimation result of a certain dimension used for convolution with the filter may be that, according to the resolution unit corresponding to the maximum value in the dimension where the first-stage over-threshold detection processing is located, the Doppler domain channel estimation result of another dimension corresponding to the resolution unit is extracted from the windowed Doppler-time domain channel estimation result. The advantage of this design is to reduce the computational complexity. For example, when the second-stage filtering processing is performed on the first dimension of the channel estimation result, according to the resolution unit corresponding to the maximum value in the dimension (second dimension) where the first-stage over-threshold detection processing is performed, the first dimension of the time-domain channel estimation result corresponding to the resolution unit may be extracted from the windowed Doppler-time-domain channel estimation result for the second-stage filtering processing. Similarly, when the second-stage filtering processing is performed on the channel estimation result of the second dimension, according to the resolution unit corresponding to the maximum value in the dimension (first dimension) where the first-stage over-threshold detection processing is performed, the second dimension of the Doppler domain channel estimation result corresponding to the resolution unit may be extracted from the windowed Doppler-time domain channel estimation result for the second-stage filtering processing.

An example implementation of the second-stage over-threshold detection is to compare the second-stage channel power difference with a second-stage power difference threshold, and a maximum value is searched in the area in which the threshold is exceeded. At this time, the number of maximum values searched is the correction result of the target number, and the resolution unit where the maximum value is located is the estimation result of the target parameter in the corresponding dimension. In one implementation, the second-stage power difference threshold may be a fixed value or a real-time calculated value related to the statistical characteristic of noise. For example, the statistical characteristic such as variance of the noise obtained by the sensing node is used for calculation of the power difference threshold. In one implementation, after the sensing node obtains the statistical characteristic such as variance of the noise, Monte Carlo method is used to generate multiple simulated random noises (denoted as second-stage noise), and the difference of the corresponding samples of the second-stage noise and the filtered second-stage noise is taken, and the maximum value of the difference is selected to obtain the first-stage power difference threshold. Especially, in the process of calculating the second-stage power difference threshold, a typical value T₂ may be added on the basis of the difference obtained by taking the the difference of the corresponding samples of the second-stage noise and the filtered second-stage noise. In one implementation, the determination of the typical value T₂ is related to the length of the filter. An example of this correlation may be that when the filter length is c₁, the aforementioned typical value is t₁, and when the filter length is c₂, the aforementioned typical value is t₂. Optionally, when c₁>c₂, t₁<t₂, that is, the smaller the length of the filter, the larger the typical value should be set, so as to prevent the power spike generated by random noise from being determined as the target. Optionally, when the filter length is greater than a certain value (denoted as c₃), the above-mentioned typical value is t₃, thereby improving the accuracy of judging whether the target exists or not. For example, when the filter length is greater than 119, the aforementioned typical value is 0. The design benefit of this power difference threshold is to improve the accuracy of judging whether the target exists or not and/or the like.

The following gives the specific implementation method of the two-stage filtering and over-threshold detection by the sensing node according to the echo signals for multiple sensing signals. Take the first-stage filtering processing and the first-stage over-threshold detection for the first dimension of the channel estimation result, and the second-stage filtering processing and the second-stage over-threshold detection for the second dimension of the channel estimation result, and take the moving average filter as an example. In one implementation, first, the first-stage filtering processing is performed, where the moving average filtering processing is performed on the time domain estimation result h_{DD,TD}(m′, t), t=1, 2, . . . , N_{FFT} of the channel at Doppler frequency m′ for many times, where m′=1, 2, . . . , Nₚᵤₗₛₑ. In one implementation, it is assumed that the number of times of the moving average filtering is N_{MAF}, and in the k-th moving average filtering operation, the length of the moving average filter is set to Qₖ, where the parameter Qₖ may be an arbitrary odd number greater than 1, which is a preset parameter. The k-th moving average filtering is performed on h_{DD,TD}(m′, t) to obtain h_{DD,TD,MAF,k}(m′, t). In one implementation, when

$$1 \leq t \leq \frac{{Q}_{k} - 1}{2} , {h}_{DD , TD , MAF , k} ( {m}^{′} , t ) = \frac{1}{2 t - 1} {\sum }_{i = 1}^{2 t - 1} {h}_{DD , TD} ( {m}^{′} , i ) ; when$$

$$\frac{{Q}_{k} - 1}{2} < t \leq {N}_{FFT} - \frac{{Q}_{k} - 1}{2} ,$$

$${h}_{DD , TD , MAF , k} ( {m}^{′} , t ) = \frac{1}{{Q}_{k}} {\sum }_{i = t - \frac{{Q}_{{k}^{- 1}}}{Z}}^{t {+}^{\frac{{Q}_{k} - 1}{2}}} {h}_{DD , TD} ( {m}^{′} , i ) ; when$$

$${N}_{FFT} - \frac{{Q}_{k - 1}}{2} < t \leq {N}_{FFT} ,$$

$${h}_{DD , TDMAF , k} ( {m}^{′} , t ) = \frac{1}{2 ( {N}_{FFT} - t ) + 1} {\sum }_{i = 2 t - {N}_{F F T}}^{{N}_{FFT}} {h}_{DD , TD} ( {m}^{′} , i ) .$$

The difference between h_{DD,TD}(m′, t) and h_{DD,TD,MAF,k}(m′, t) is calculated, denoted as h_{DD,TD,diff,k}(m′, t)=h_{DD,TD}(m′, t)−h_{DD,TD,MAF,k}(m′, t), t=1, 2, . . . , N_{FFT}. In one implementation, the cyclic moving average filtering processing is performed on the channel time domain estimation result h_{DD,TD}(m′, t), t=1, 2, . . . , N_{FFT} at Doppler frequency m′ for many times. In one implementation, the cyclic moving average filtering is performed on h_{DD,TD}(m′, t) to obtain h_{DD,TD,CMAF,k}(m′, t). when

$$1 \leq t \leq \frac{{Q}_{k} - 1}{2} ,$$

$${h}_{D D , TD , CMA , k} ( {m}^{′} , t ) = \frac{1}{{Q}_{k}} ( {\sum }_{i = 1}^{t + \frac{{Q}_{k} - 1}{2}} {h}_{D D , T D} ( {m}^{′} , i ) + {\sum }_{i = t + {N}_{F F T} - \frac{{Q}_{k} - 1}{2} + 2}^{{N}_{F F T}} {h}_{D D , T D} ( {m}^{′} , i ) ) ; when$$

$$\frac{{Q}_{k} - 1}{2} < t \leq {N}_{F F T} - \frac{{Q}_{k} - 1}{2} , ;$$

$${h}_{DD , TD , CMAF , k} ( {m}^{′} , t ) = \frac{1}{{Q}_{k}} {\sum }_{i = t - \frac{{Q}_{k} - 1}{2}}^{t + \frac{{Q}_{k} - 1}{2}} {h}_{D D , T D} ( {m}^{′} , i ) ; when$$

$${N}_{FFT} - \frac{{Q}_{k - 1}}{2} < t \leq {N}_{FFT} ,$$

$${h}_{D D , T D , C MAF , k} ( {m}^{′} , t ) = \frac{1}{{Q}_{k}} ( {\sum }_{i = 1}^{t - {N}_{FFT} + \frac{{Q}_{k} - 1}{2} + 1} {h}_{DD , TD} ( {m}^{′} , i ) + {\sum }_{i = t - \frac{{Q}_{k} - 1}{2}}^{{N}_{FFT}} {h}_{DD , TD} ( {m}^{′} , i ) ) .$$

The difference between h_{DD,TD}(m′, t) and h_{DD,TD,CMAF,k}(m′, t) is calculated, denoted as h_{DD,TD,diff,k}(m′, t)=h_{DD,TD}(m′, t)−h_{DD,TD,CMAF,k}(m′, t), t=1, 2, . . . , N_{FFT}. The beneficial effect of this step is that when the target is too close to the sensing node, the moving average filtering result of the channel estimation value is more accurate, thereby improving the target detection performance in time domain. Next, the first-stage over-threshold detection is implemented. In one implementation, it is assumed that the number of times of moving average filtering is N_{MAF}, and in the k-th moving average filtering operation, the length of the moving average filter is set to Qₖ. Then, by modeling the noise, the statistical characteristic of the noise is extracted to calculate the power difference threshold. In one implementation, the sensing node estimates the variance of the noise, and generates a noise vector with the corresponding variance by using a simulation method, which is denoted as n₁(mt), t=1, 2, . . . , N_{FFT}. Then, Fourier transform is performed on n₁(mt) and windowing with w(n) is performed in frequency domain, and then the time domain noise n̅₁(mt), t=1, 2, . . . , N_{FFT} windowed in frequency domain is obtained by inverse Fourier transform. n̅₁(mt) is processed by using a moving average filter or a cyclic moving average filter with length Qₖ, and the processing result is denoted as n₂(mt). It should be noted that the filter length of the k-th moving average filtering of the noise needs to be the same as that of the k-th moving average filtering of the echo to be processed. The difference between ñ₁(t) and n₂(t) is calculated, denoted as n_{diff,k}(t)=n̅₁(t)−n₂(t), and

$${p}_{T h , k} = {max}_{t} ( {n}_{diff , k} ( t ) )$$

is set as the threshold corresponding to the filter with length. In actual reception, the sensing node may generate multiple pieces of noise through simulation and process them separately, and take the maximum value of the multiple

$${max}_{t} ( {n}_{diff , k} ( t ) )$$

obtained after the k-th moving average filtering as the threshold. In addition, when the window length is smaller, in order to prevent the random spike in noise from being determined as the target, when setting the threshold, the typical value Δp may be added to

$${max}_{t} ( {n}_{diff , k} ( t ) )$$

as the threshold, that is

$${p}_{Th , k} = {max}_{t} ( {n}_{diff , k} ( t ) ) + Δ p .$$

Theoretically, the smaller the window length, the larger the typical value Δp should be set. Considering the difference h_{DD,TD,diff,k}(m′, t) between the time domain channels at Doppler frequency m′ before and after smoothing, if ∀t,h_{DD,TD,diff,k}(m′, t)≤p_{Th,k}, the system determines that there is no target at the Doppler frequency m′ after the k-th moving average filtering in the sensing area; otherwise, a maximum value is searched at all that satisfy. Assuming that N_{k,m}, maximum values are searched at the Doppler frequency m′ after the k-th moving average filtering, in which the position of the i-th maximum value is denoted as t_{max, k,m′,i}, then the set of maximum value positions searched at the Doppler frequency m′ after the k-th moving average filtering is denoted as

$${𝒯}_{k , {m}^{′}} = {⋃}_{i = 1}^{{N}_{{m}^{′}}} {t}_{max , k , {m}^{′} , i} .$$

Taking the union of the N_{MAF} moving average results, the set of maximum value positions at Doppler frequency m′ is denoted as

$${𝒯}_{{m}^{′}} = {⋃}_{i = 1}^{{N}_{MAF}} {𝒯}_{i , {m}^{′}} .$$

The Nₚᵤₗₛₑ time domain channel processing results corresponding to the Doppler frequency m′ are compared with the threshold and maximum search is performed to obtain Nₚᵤₗₛₑ groups of estimation results, and the union of the Nₚᵤₗₛₑ groups of results is taken to obtain the set of maximum value positions

$$𝒯 = {⋃}_{i = 1}^{{N}_{pulse}} {𝒯}_{i} .$$

The number of elements in the set [symbol] is the number of targets sensed at this time, and the elements in the set [symbol] are the time domain sampling times corresponding to each target. Accordingly, the corresponding target distance at the sampling time t_{max,k,m′,i} is

$$R = \frac{{t}_{max , k , {m}^{′} , i} \cdot c}{2 \cdot {F}_{s}} m ,$$

where c is the speed of light in m/s and Fₛ is the sampling rate in Hz. Then, the second-stage moving average filtering process is implemented to extract the Doppler domain of the channel estimation result corresponding to the elements in the sampling time set [symbol] . In one implementation, for any tₘₐₓ∈ [symbol] , the Doppler domain of the channel estimation result h_{DD,TD}(m,tₘₐₓ),m=1, 2, . . . , Nₚᵤₗₛₑ corresponding to the sampling time tₘₐₓ is obtained. The moving average filtering processing is performed on h_{DD,TD}(m,tₘₐₓ),m=1, 2, . . . , Nₚᵤₗₛₑ, for many times. In one implementation, it is assumed that the number of times of the moving average filtering is N_{MAF}, and in the k-th moving average filtering operation, the length of the moving average filter is set to Qₖ, where the parameter may be an arbitrary odd number greater than 1, which is a preset parameter. h_{DD,TD,MAF,k}(m,tₘₐₓ) is obtained by performing the k-th moving average filtering on h_{DD,TD}(m,tₘₐₓ). In one implementation, when

$$1 \leq m \leq \frac{{Q}_{k} - 1}{2} , {h}_{D D , TD , MAF , k} ( m ) = \frac{1}{2 m - 1} {\sum }_{i = 1}^{2 m - 1} {h}_{D D , T D} ( i , {t}_{max} ) ; when$$

$$\frac{{Q}_{k} - 1}{2} < m \leq {N}_{p u l s e} - \frac{{Q}_{k} - 1}{2} ,$$

$${h}_{D D , TD , MAF , k} ( m ) = \frac{1}{{Q}_{k}} {\sum }_{i = m - \frac{{Q}_{k} - 1}{2}}^{m + \frac{{Q}_{k} - 1}{1}} {h}_{D D , T D} ( i , {t}_{max} ) ; when$$

$${N}_{FFT} - \frac{{Q}_{k} - 1}{2} < m \leq {N}_{p u l s e} ,$$

$${h}_{DD , TD , MAF , k} ( m ) = \frac{1}{2 ( {N}_{pulse} - m ) + 1} {\sum }_{i = 2 m - {N}_{pulse}}^{{N}_{pulse}} {h}_{DD , TD} ( i , {t}_{max} ) .$$

The difference between h_{DD,TD}(m,tₘₐₓ) and h_{DD,TD,MAF,k}(m,tₘₐₓ) is calculated, denoted as h_{DD,TD,diff,k}(m,tₘₐₓ)=h_{DD,TD}(m,tₘₐₓ)−h_{DD,TD,MAF,k}(m,tₘₐₓ), t=1, 2, . . . , N_{FFT}. Then, the second-stage over-threshold detection is implemented, in which the sensing node does not transmit the sensing signal, and receives signals for a period of time, and determines that the received signal as noise, denoted as n₁(t), t=1, . . . , NₚᵤₗₛₑN_{FFT}. n₁ is divided equally into Nₚᵤₗₛₑ parts to obtain n₂(p,t)=n₁((p−1) N_{FFT}+t), where p=1, 2, . . . , Nₚᵤₗₛₑ, t=1, 2, . . . , N_{FFT}. Fourier transform is performed on n₂(p′,t) corresponding to each p′, and windowing with w(n) is performed in frequency domain, and then the time domain noise n̅₂(p′,t), t=1, 2, . . . , N_{FFT} windowed in frequency domain is obtained by inverse Fourier transform. Then, the noise vector n̅₂(p,t′),p=1, 2, . . . , Nₚᵤₗₛₑ corresponding to the t′-th sampling time is subjected to size Nₚᵤₗₛₑ Fourier transform to obtain the Doppler domain channel estimation result corresponding to the t′-th sampling time, which is denoted as ñ₄(m,t′),m=1, 2, . . . , Nₚᵤₗₛₑ. n̅₄(m,t) represents the corresponding noise power at the Doppler frequency m′ at sampling time t after windowing in frequency domain. It is assumed that the number of times of the moving average filtering in Doppler domain is N_{MAF}, and in the k-th moving average filtering operation, the length of the moving average filter is set to Qₖ. Take the t′-th column of n̅₄(m,t), denoted as n̅₄(m,t′),m=1, 2, . . . , Nₚᵤₗₛₑ. n̅₄(m,t′),m=1, 2, . . . , Nₚᵤₗₛₑ is processed by using a moving average filter or cyclic moving average filter with length Qₖ, and the processing result is denoted as n_{MAF,k}(m,t′),m=1, 2, . . . , Nₚᵤₗₛₑ. It should be noted that the filter length of the k-th moving average filtering of noise needs to be the same as that of the k-th moving average filtering of the echo to be processed. The difference between n̅₄(m,t′) and n_{MAF,k}(m,t′) is calculated, and

$${P}_{Th , DD , k} = {max}_{{t}^{′}} ( {n}_{diff , k} ( m , {t}^{′} ) )$$

is set as the threshold corresponding to the filter with length Qₖ. In actual reception, the sensing node may receive multiple pieces of noise for multiple processing, and take the maximum value of multiple max(n′) for a certain filter length as the threshold. In addition, when the window length is smaller, in order to prevent the random spike in noise from being determined as the target, when setting the threshold, the typical value Δp may be added to

$${max}_{{t}^{′}} ( {n}_{diff , k} ( m , {t}^{′} ) )$$

as the threshold, that is

$${p}_{Th , DD , k} = {max}_{{t}^{′}} ( {n}_{diff , k} ( m , {t}^{′} ) ) + Δ p .$$

Theoretically, the smaller the window length, the larger the typical value should be set. For any tₘₐₓ∈ [symbol] , the difference of Doppler domain channel estimation results before and after the k-th moving average filtering is h_{DD, TD.diff,k}(m,tₘₐₓ),m=1, 2, . . . , Nₚᵤₗₛₑ. For a certain tₘₐₓ∈ [symbol] , if ∀m,h_{DD,TD,diff,k}(m,tₘₐₓ)≤p_{Th,DD,k}, it is determined that there is no target in the distance corresponding to the sampling time after the k-th moving average filtering; otherwise, a maximum value is searched at all m* that satisfy h_{DD,TD,diff,k}(m*, tₘₐₓ)>p_{Th,DD,k}. Assuming that Nₖ maximum values are searched, in which the position of the i-th maximum value is denoted as m_{max,k,i}, the set of maximum value positions searched after the k-th moving average filtering at the sampling time tₘₐₓ is denoted as

$${ℳ}_{k , {t}_{max}} = {⋃}_{i = 1}^{{N}_{k}} {m}_{max , k , i} .$$

Take the union of the N_{MAF} moving average results to obtain the set of maximum value positions

$${ℳ}_{{t}_{max}} = {⋃}_{i = 1}^{{N}_{MAF}} {ℳ}_{m , {t}_{max}}$$

at the sampling time tₘₐₓ. The number of elements in the set [symbol] is the number of targets corresponding to the sampling time tₘₐₓ, and the elements in the set [symbol] are the Doppler frequency corresponding to the sampling time. Accordingly, the target speed at the Doppler frequency m′ is

$$\frac{- ( {m}_{max , k , i} - \frac{{N}_{pulse}}{2} - 1 ) \cdot PRF \cdot λ}{2 \cdot {N}_{pulse}} m / s ,$$

where PRF is the repetition frequency of the sensing signal in Hz and λ is the wavelength of the sensing signal in m.

In one implementation, when the sensing node transmits the multiple sensing signals and receives the multiple echoes, in addition to the above-mentioned methods of filtering and over-threshold detection in the first dimension and the second dimension respectively, as another implementation of the detection method for obtaining the number, distance and radial velocity of targets, the sensing node may also perform two-dimensional joint filtering operation and two-dimensional joint over-threshold detection operation according to the windowed Doppler-time domain channel estimation result of the multiple echoes. The two-dimensional joint over-threshold detection is used to output one or more of target number detection results and target parameters, where the target parameters include the distance between the target and the sensing node and the radial velocity of the target relative to the sensing node.

One possible implementation of the two-dimensional joint filtering is to generate a two-dimensional filter with a first dimension length L₁ and a second dimension length L₂, and perform two-dimensional convolution on the Doppler-time domain channel estimation result and the two-dimensional filter to obtain the convolved Doppler-time domain channel estimation result. One generation method of the two-dimensional filter is to first generate a third filter f₃(n),n=1, 2, . . . , L₁ with length L₁ and a fourth filter f₄(m),m=1, 2, . . . , L₂ with length L₂, and then the generation method of the two-dimensional filter is as follows, g(n,m)=f₃(n)f₄(m),n=1, 2, . . . , L₁, m=1, 2, . . . , L₂. In one implementation, when filtering the channel estimation result, multiple two-dimensional filters are generated, and the same channel estimation result is processed by using multiple filters, where the different filters may be the same type of filters with different lengths, different types of filters with the same length, or different types of filters with different lengths. The design advantage of using different filters to process the same channel estimation results is that filters may be designed for targets with different radar cross-sectional areas, and the detection performance may be optimized in the scene where the distribution of target radar cross-sectional areas is random.

In one implementation, the determination of filter length is related to the scene where the sensing node is located and the expectation of system detection performance. Taking the radar cross-sectional area distribution of the target type expected to be detected by the sensing system and the filter length as examples, the relationship between the expectation of system detection performance and the setting of filter length is explained below. Without losing generality, this correlation may be extended to the scene where the sensing node is located and the setting of filter length. An example of this correlation may be that when the radar cross-sectional area range of the target that the sensing node expects to detect is smaller (denoted as [a₁, b₁]), the lengths of the two-dimensional filter in the first dimension and the second dimension are c₁ and d₁, respectively, and when the radar cross-sectional area range of the target that the sensing node expects to detect is larger (denoted as [a₂, b₂]), the lengths of the two-dimensional filter in the first dimension and the second dimension are c₂ and d₂, respectively. c₁, d₁, c₂ and d₂ may be set to any real number, and optionally, may be set to any odd number. Optionally, when b₁−a₁<b₂−a₂, c₁>c₂ and d₁>d₂. Furthermore, the lengths L₁ and L₂ of the shorter filters may be set to odd numbers such as 7, 9, 11, etc, the lengths L₁ and L₂ of the medium filters may be set to 21, 31, 41, etc, and the lengths L₁ and L₂ of the longer filters may be set to 119, 129, etc. It should be noted that the length of any one of the two dimensions of the two-dimensional joint filter cannot exceed the length of data in this dimension, that is, the length of the first dimension of the two-dimensional joint filter cannot exceed the number of sampling points of the channel estimation result of a single sensing signal, and the length of the second dimension of the two-dimensional joint filter cannot exceed the number of received sensing signals (or the number of sampling points of the channel estimation result in Doppler domain).

One possible implementation of the two-dimensional joint over-threshold detection is to take the difference between the windowed Doppler-time domain channel estimation result and the filtered Doppler-time domain channel estimation result, compare the difference with a two-dimensional joint power difference threshold, and search for a maximum value in the area in which the threshold is exceeded, where the number of maximum values searched is the estimated number of targets, and the resolution unit (that is, sampling time) in the first dimension corresponds to the distance between the target and the sensing node, and the coordinate of the second dimension (that is, the Doppler frequency) of the maximum value corresponds to the radial velocity of the target relative to the sensing node. The design benefit of this two-dimensional joint over-threshold detection is to improve the detection accuracy of the existence of the target. Because of the joint processing and maximum search in the first dimension and the second dimension, the maximum value output is both the maximum value for the first dimension and the maximum value for the second dimension.

In one implementation, the two-dimensional joint power difference threshold can be a fixed value or a real-time calculated value related to the statistical characteristic of noise, for example, the statistical characteristic such as variance of the noise obtained by the sensing node is used for calculation of the power difference threshold. In one implementation, after the sensing node obtains the statistical characteristic such as variance of the noise, the Monte Carlo method is used to generate multiple two-dimensional simulations of random noise (denoted as two-dimensional joint noise), and the difference of the corresponding samples of the two-dimensional joint noise and the filtered two-dimensional joint noise is taken, and the maximum value of the difference is selected to obtain the two-dimensional joint power difference threshold. Especially, in the process of calculating the two-dimensional joint power difference threshold, the typical value T′ may be added on the basis of the difference obtained by taking the difference of the corresponding samples of the two-dimensional joint noise and the filtered two-dimensional joint noise. In one implementation, the determination of the typical value T′ is related to the length of the filter. An example of this correlation may be that when the lengths of the two-dimensional filter in the first dimension and the second dimension are c₁ and d₁ respectively, the aforementioned typical value is t₁, and when the lengths of the two-dimensional filter in the first dimension and the second dimension are c₂ and d₂ respectively, the aforementioned typical value is t₂. Optionally, when c₁>c₂ and d₁>d₂, t₁<t₂, that is, the shorter the length of the filter, the larger the typical value should be set, so as to prevent the power spike generated by random noise from being determined as the target. When the length of the two-dimensional filter in the first dimension is greater than a certain value (denoted as c₃), or the length of the two-dimensional filter in the second dimension is greater than a certain value (denoted as d₃), the above-mentioned typical value is t₃, thereby improving the accuracy of judging whether the target exists or not. For example, when the length of the two-dimensional filter in the first dimension is greater than 119, or the length of the two-dimensional filter in the second dimension is greater than 29, the aforementioned typical value is 0.

The following gives the specific implementation method of two-dimensional joint filtering and two-dimensional joint over-threshold detection by the sensing node according to the echo signals for multiple sensing signals. Taking the filter selection as a moving average filter as an example, first, the channel estimation result h_{DD,TD}(m,t) is processed by the two-dimensional joint filtering for many times. Assuming that the number of times of the moving average filtering is N_{MAF}, in one implementation, in the k-th moving average filtering operation, the moving average filter length in time domain is set to Q_{TD,k}, and the moving average filter length in the Doppler domain is set to Q_{DD,k}, where the parameter Q_{TD,k} and parameter Q_{DD,k} may be any odd number greater than 1, which are preset parameters. The k-th two-dimensional moving average filtering is performed on h_{DD,TD}(m,t) to obtain h_{DD,TD, MAF,k}(m,t). In one implementation, when

$$1 \leq m \leq \frac{{Q}_{DD , k} - 1}{2} , 1 \leq t \leq \frac{{Q}_{TD , k} - 1}{2} ,$$

$${h}_{DD , TD , MAF , k} ( m , t ) = \frac{1}{( 2 t - 1 ) ( 2 m - 1 )} {\sum }_{{i}_{t} = 1}^{2 t - 1} {\sum }_{{i}_{m} = 1}^{2 m - 1} {h}_{DD , TD} ( {i}_{m} , {i}_{t} ) ,$$

$$when 1 \leq m \leq \frac{{Q}_{DD , k} - 1}{2} , \frac{{Q}_{TD , k} - 1}{2} < t \leq {N}_{FFT} - \frac{{Q}_{TD , k} - 1}{2} ,$$

$${h}_{DD , TD , MAF , k} ( m , t ) = \frac{1}{{Q}_{TD , k} ( 2 m - 1 )} {\sum }_{{i}_{t} = t \frac{{Q}_{TD , k} - 1}{2}}^{t + \frac{{Q}_{TD , k} - 1}{2}} {\sum }_{{i}_{m} = 1}^{2 m - 1} {h}_{DD , TD} ( {i}_{m} , {i}_{t} ) ,$$

$$when 1 \leq m \leq \frac{{Q}_{DD , k} - 1}{2} , {N}_{FFT} - \frac{{Q}_{TD , k} - 1}{2} < t \leq {N}_{FFT} ,$$

$${h}_{DD , TD , MAF , k} ( m , t ) \frac{1}{( 2 ( {N}_{FFT} - t ) + 1 ) ( 2 m - 1 )} {\sum }_{{i}_{t} = 2 t - {N}_{FFT}}^{{N}_{FFT}} {\sum }_{{i}_{m} = 1}^{2 m - 1} {h}_{DD , TD} ( {i}_{m} , {i}_{t} ) ,$$

$$when {h}_{DD , TD , MAF , k} ( m , t ) = \frac{1}{( 2 t - 1 ) {Q}_{DD , k}} {\sum }_{{i}_{t} = 1}^{2 t - 1} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when \frac{{Q}_{DD , k} - 1}{2} < m \leq {N}_{pulse} - \frac{{Q}_{DD , k} - 1}{2} , \frac{{Q}_{TD , k} - 1}{2} < t \leq {N}_{FFT} - \frac{{Q}_{TD , k} - 1}{2} ,$$

$${h}_{DD , TD , MAF , k} ( m , t ) = \frac{1}{{Q}_{TD , k} {Q}_{DD , k}} {\sum }_{{i}_{t} = t - \frac{{Q}_{TD , k} - 1}{2}}^{t + \frac{{Q}_{TD , k} - 1}{2}} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when \frac{{Q}_{DD , k} - 1}{2} < m \leq {N}_{pulse} - \frac{{Q}_{DD , k} - 1}{2} , {N}_{FFT} - \frac{{Q}_{TD , k} - 1}{2} < t \leq {N}_{FFT} ,$$

$${h}_{DD , TD , MAF , k} ( m , t ) = \frac{1}{( 2 ( {N}_{FFT} - t ) + 1 ) {Q}_{DD , k}} {\sum }_{{i}_{t} = 2 t - {N}_{FFT}}^{{N}_{FFT}} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when {N}_{FFT} - \frac{{Q}_{DD , k} - 1}{2} < m \leq {N}_{pulse} , 1 \leq t \leq \frac{{Q}_{TD , k} - 1}{2} ,$$

$${h}_{DD , TD , MAF , k} ( m , t ) = \frac{1}{( 2 t - 1 ) ( 2 ( {N}_{pulse} - m ) + 1 )} {\sum }_{{i}_{t} = 1}^{2 t - 1} {\sum }_{{i}_{m} = 2 m - {N}_{pulse}}^{{N}_{pulse}} {h}_{DD , TD} ( {i}_{m} , {i}_{t} ) ,$$

$$when {N}_{FFT} - \frac{{Q}_{DD , k} - 1}{2} < m \leq {N}_{pulse} , \frac{{Q}_{TD , k} - 1}{2} \leq t \leq {N}_{FFT} - \frac{{Q}_{TD , k} - 1}{2} ,$$

$${h}_{DD , TD , MAF , k} ( m , t ) = \frac{1}{{Q}_{TD , k} ( 2 ( {N}_{pulse} - m ) + 1 )} {\sum }_{{i}_{t} = t - \frac{{Q}_{TD , k} - 1}{2}}^{t + \frac{{Q}_{TD , k} - 1}{2}} {\sum }_{{i}_{m} = 2 m - {N}_{pulse}}^{{N}_{pulse}} {h}_{DD , TD} ( {i}_{m} , {i}_{t} ) ,$$

$$when {N}_{FFT} - \frac{{Q}_{DD , k} - 1}{2} < m \leq {N}_{pulse} , {N}_{FFT} - \frac{{Q}_{TD , k} - 1}{2} \leq t \leq {N}_{FFT} ,$$

$${h}_{DD , TD , MAF , k} ( m , t ) = \frac{1}{( 2 ( {N}_{FFT} - t ) + 1 ) ( 2 ( {N}_{pulse} - m ) + 1 )} {\sum }_{{i}_{t} = 2 t - {N}_{FFT}}^{{N}_{FFT}} {\sum }_{{i}_{m} = 2 m - {N}_{pulse}}^{{N}_{pulse}} {h}_{DD , TD} ( {i}_{m} , {i}_{t} ) .$$

The difference between h_{DD,TD}(m,t) and h_{DD,TD,MAF,k}(m,t) is calculated, denoted as h_{DD,TD,diff,k}(m,t)=h_{DD,TD}(m,t)−h_{DD,TD, MAF,k}(m,t),m=1, 2, . . . , Nₚᵤₗₛₑ, t=1, 2, . . . , N_{FFT}. Then, the two-dimensional over-threshold detection is performed. Then, by modeling the noise, the statistical characteristic of the noise is extracted to calculate the power difference threshold. In one implementation, the sensing node estimates the variance of the noise, and generates a noise vector with the corresponding variance by using a simulation method, which is denoted as n₁(mt), t=1, . . . , Nₚᵤₗₛₑ N_{FFT}. n₁ is divided equally into Nₚᵤₗₛₑ parts to obtain n₂(p,t)=n₁(m(p−1) N_{FFT}+t), where p=1, 2, . . . , Nₚᵤₗₛₑ, t=1, 2, . . . , N_{FFT}. Fourier transform is performed on n₂(p′,t) corresponding to each p′, and windowing with w(n) is performed in frequency domain, and then the time domain noise n̅₂(p′,t), t=1, 2, . . . , N_{FFT} windowed in frequency domain is obtained by inverse Fourier transform. Then, the noise vector n̅₂(p,t′),p=1, 2, . . . , Nₚᵤₗₛₑ corresponding to the t′-th sampling time is subjected to size Nₚᵤₗₛₑ Fourier transform to obtain the Doppler domain channel estimation result corresponding to the t′-th sampling time, which is denoted as ñ₄(m,t′),m=1, 2, . . . , Nₚᵤₗₛₑ. n̅₄(m,t) represents the corresponding noise power at the Doppler frequency m at sampling time t after windowing in frequency domain. By performing the two-dimensional moving average filtering on the noise, the noise power difference thresholds corresponding to two-dimensional moving average filtering with different lengths are determined. In one implementation, it is assumed that the number of times of the two-dimensional moving average filtering is N_{MAF}, and in the k-th moving average filtering operation, the moving average filter length in time domain is set to Q_{TD,k}, and the moving average filter length in Doppler domain is set to Q_{DD,k}. In the k-th moving average filtering operation of noise, the k-th moving average filtering result n_{MAF,k}(m,t) of the noise is obtained by passing ñ₄(m,t′) through the same moving average filter as the above-mentioned filter of h_{DD,TD}(m,t). The difference of ñ₄(m,t′) and n_{MAF,k}(m,t) is calculated, denoted as n_{diff,k}(m,t)=n̅₄(m,t′)−n_{MAF,k}(m,t), and

$${p}_{Th , k} = {max}_{m , t} ( {n}_{diff , k} ( m , t ) )$$

is set as the threshold value corresponding to the filtering operation with the length Q_{TD,k} of the time domain moving average filter and the length Q_{DD,k} of the Doppler domain moving average filter. In actual reception, the sensing node may simulate and generate multiple pieces of noise to process separately, and take the maximum value of multiple

$${max}_{m , t} ( {n}_{diff , k} ( m , t ) )$$

for a certain filter length as the threshold. In addition, when the window length is smaller, in order to prevent the random spike in noise from being determined as the target, when setting the threshold, the typical value may be added Δp to

$${max}_{m , t} ( {n}_{diff , k} ( m , t ) )$$

as the threshold, that is,

$${p}_{Th , k} = {max}_{m , t} ( {n}_{diff , k} ( m , t ) ) + Δ p .$$

Theoretically, the smaller the window length, the larger the typical value should be. Considering the difference between the Doppler domain and the time domain channel estimation results before and after passing through the moving average filter for the k-th time, if ∀t,∀m,h_{DD,TD,diff,k}(m,t)≤p_{Th,k}, it is determined that there is no target in the sensing area; otherwise, a maximum value is searched at all (m*, t*) that satisfy h_{DD,TD,diff,k}(m*, t*)>p_{Th,k}. Assuming that Nₖ maximum values are searched after the k-th moving average filtering, in which the position of the i-th maximum value is denoted as (m_{max,k,i}, t_{max,k,i}), and the set of maximum value positions Is denoted as

$${𝒯}_{k} = {⋃}_{i = 1}^{{N}_{k}} ( {m}_{max , k , i} , {t}_{max , k , i} ) .$$

Taking the union of the N_{MAF} moving average results, the set of maximum value positions is denoted as

$$𝒯 = {⋃}_{i = 1}^{{N}_{MAF}} {𝒯}_{k} .$$

The number of elements in the set [symbol] is the number of targets sensed at this time, and the elements in the set [symbol] are the Doppler frequency and time domain sampling time corresponding to each target. Accordingly, the target speed at the Doppler frequency m_{max,k,i} is

$$\frac{- ( {m}_{max , k , i} - \frac{{N}_{pulse}}{2} - 1 ) \cdot PRF \cdot λ}{2 \cdot {N}_{pulse}} m / s ,$$

where PRF is the repetition frequency of the sensing signal in Hz and λ is the wavelength of the sensing signal in m. The corresponding target distance at the sampling time t_{max,k,i} is

$$R = \frac{{t}_{max , k , i} \cdot c}{2 \cdot {F}_{s}} m ,$$

where c is the speed of light in m/s and Fₛ is the sampling rate in Hz.

The second method has the characteristics of good detection performance and insensitivity to the elevation of echo sidelobe power, which supports the detection of different types of targets from the scene and may be applied to the identification of multiple point targets in complex environment.

Considering the communication and sensing integration scene that requires higher accuracy of distance and velocity estimation of the target, the radar cross-sectional area of the target and the distance between the target and the sensing node are randomly distributed, and high radar cross-sectional area or too close to the sensing node will lead to the increasement of the target echo power. By windowing the channel estimation result, the sidelobe of the echo signal may be lowered, thereby improving the detection probability of long-distance targets and low radar cross-sectional targets, but at the same time, it also increases the resolution of target parameter estimation and the error between the estimated value and the real value.

In order to solve the above problems, this patent also proposes the following target parameter estimation algorithm, which may estimate the number of targets and the target parameters (such as the distance between the target and the sensing node, the radial velocity of the target relative to the sensing node, and/or the like), and correct the estimation results of the target parameters. This method may reduce the error between the estimated value and the real value and has good estimation performance.

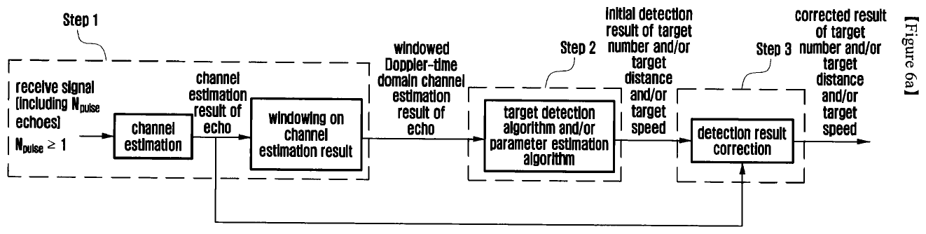

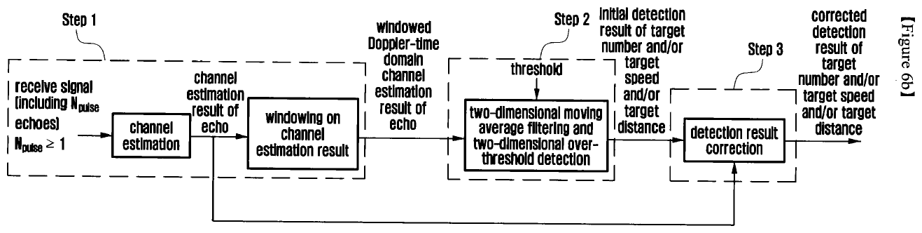

A feasible algorithm for correcting the estimation result of target parameters (hereinafter referred to as method 3) adds a step of estimation result correction on the basis of method 1 and method 2. Echo signals for single or multiple sensing signals transmitted by the sensing node are processed to obtain channel estimation and Doppler estimation results, and determining the distance and/or speed of the target according to the time domain characteristics and Doppler domain estimation results of the estimated channel. For example, the distance of the target may be determined according to the channel estimation result of the single echo or the distance and speed of the target may be determined according to the channel estimation results of multiple echoes. The flow is shown in FIG. 6A, and the specific steps are as follows:

Step 1: the sensing node transmits a single or multiple sensing signals to a specific sensing area (if a specific transmit beam is used, the specific sensing area is the coverage of the specific transmit beam), receives an echo signal of the sensing signal, performs channel estimation on the echo signal to obtain a channel estimation result of the echo, and performs windowing on the channel estimation result to obtain a windowed channel estimation result.

In one implementation, when the sensing node transmits the single sensing signal, the sensing node receives the time domain signal of the echo for the single sensing signal, and performs frequency domain channel estimation on the time domain signal of the single echo to obtain a frequency domain channel estimation result of the single echo. A window function with length N is generated, and the frequency domain channel estimation result corresponding to the sample index is multiplied by the window function to obtain the windowed frequency domain channel estimation result. Then the windowed frequency domain channel estimation result is subjected to IDFT/IFFT to obtain the windowed time domain channel estimation result of the single echo. Here, N is the number of sampling points of the single echo, or the length of channel estimation result in time domain/frequency domain, and the size of DFT/FFT/IDFT/IFFT between the time domain and frequency domain. In one implementation, time domain channel estimation is performed on the time domain signal of the single echo to obtain the time domain channel estimation result of the single echo. A window function with length N is generated, and the time domain expression of the window function with length N is obtained by performing size N IDFT/IFFT on the window function. The time domain channel estimation result of the single echo is convolved with the time domain expression of the window function to obtain the windowed time domain channel estimation result of the single echo

In one implementation, when the sensing node transmits the multiple sensing signals, the echoes are stored as a two-dimensional matrix first, where each echo corresponds to one dimension of the two-dimensional matrix (short-time processing dimension, that is, the time dimension within a single sensing signal, hereinafter referred to as the first dimension), and the number of sensing signals is another dimension of the two-dimensional matrix (long-time processing dimension, that is, the number dimension of sensing signals, hereinafter referred to as the second dimension). First, in the first dimension, frequency domain channel estimation is performed on each single echo to obtain the frequency domain channel estimation result of the single echo. A first window function with length N is generated, and the frequency domain channel estimation result corresponding to the sample index is multiplied by the first window function to obtain the windowed frequency domain channel estimation result. Then the windowed frequency domain channel estimation result is subjected to IDFT/IFFT to obtain the windowed time domain channel estimation results of the single echo. Here, N is the number of sampling points of the single echo, or the length of channel estimation result in time domain/frequency domain, and the size of DFT/FFT/IDFT/IFFT between the time domain and frequency domain. In one implementation, time domain channel estimation is performed on the time domain signal of the single echo to obtain the time domain channel estimation result of the single echo. A window function with length N is generated, and the time domain expression of the window function with length N is obtained by performing IDFT/IFFT on the window function. The time domain channel estimation result of the single echo is convolved with the time domain expression of the window function to obtain the windowed time domain channel estimation result of the single echo. After each echo is processed by the above-mentioned first dimension processing, the windowed time domain channel estimation results of the multiple echo are obtained. In the second dimension, a second window function with length M is generated, and the second dimension of the time domain channel estimation result corresponding to the sample index is multiplied by the window function to obtain the second dimension of the windowed time domain channel estimation result. Then size M DFT/FFT is performed on the second dimension of the windowed time domain channel estimation result to obtain the windowed Doppler domain channel estimation result. Here, M is the number of sensing signals transmitted by the sensing node, or the size of DFT/FFT/IDFT/IFFT between the time domain and the Doppler domain of the second dimension. In one implementation, size M DFT/FFT is performed on the windowed time domain channel estimation result of the multiple echoes in the second dimension to obtain the second dimension of the Doppler domain channel estimation result. A second window function with length M is generated, and size M DFT/FFT is performed on the second window function to obtain the Doppler domain expression of the second window function. The Doppler domain channel estimation result is convolved with the Doppler domain expression of the second window function to obtain the windowed Doppler domain channel estimation result. After processing the first dimension and the second dimension of the received signal, the windowed Doppler-time domain channel estimation result of the multiple echoes are obtained.

It should be noted that in the process of obtaining the windowed channel estimation result, when the sensing node transmits the multiple sensing signals, the first dimension processing and the second dimension processing of the signals are not limited in order, because the signal processing in the two dimensions is independent of each other. In one implementation, in the first dimension processing, the channel estimation result is the time domain channel estimation result; in the second dimension processing, the channel estimation result is the second dimension of the frequency domain channel estimation result (hereinafter the second dimension of the frequency domain is referred to as Doppler domain). The advantage of this design with independent windowing of two dimensions is that it is more flexible, and it can select different window functions for different dimensions according to the needs of system design.

Step 2: the sensing node performs target detection and parameter estimation on the windowed Doppler-time domain channel estimation result to obtain the number of targets and at least one or more of the following estimations for output: the distance of the target from the sensing node and the radial velocity of the target relative to the sensing node. Among them, the distance of the target from the sensing node means the distance travelled by the sensing signal from the sensing node to the target, and the radial velocity of the target relative to the sensing node means the component of the target velocity in the vertical direction of the connecting line between the target and the sensing node.

From the windowed channel estimation results, the target detection, the distance estimation between the target and the sensing node and the radial velocity estimation of the target relative to the sensing node are performed, the detection methods include but are not limited to step 2 in the first method and step 2 in the second method proposed in this patent.

FIG. 6B shows the signal processing flow chart of the embodiment in which step 2 in method 2 is adopted as this step. Taking step 2 in Method 2 as an example, the moving average filter is used as the filter. First, the two-dimensional moving average filtering is performed on the channel time domain estimation result h_{DD,TD}(m,t) for many times. Assuming that the number of times of the moving average filtering is N_{MAF}, in one implementation, in the k-th moving average filtering operation, the moving average filter length in time domain is set to Q_{TD,k}, and the moving average filter length in the Doppler domain is set to Q_{DD,k}, where the parameter Q_{TD,k} and parameter Q_{DD,k} may be any odd number greater than 1, which are preset parameters. By the k-th two-dimensional moving average filtering is performed on h_{DD,TD}(m,t) to obtain h_{DD,TD,MAF,k}(m,t). In one implementation, when

$$1 \leq m \leq \frac{{Q}_{DD , k} - 1}{2} , 1 \leq t \leq \frac{{Q}_{TD , k} - 1}{2} ,$$

$${h}_{DD , TD , MAF , k} ( m , t ) = \frac{1}{( 2 t - 1 ) ( 2 m - 1 )} {\sum }_{{i}_{t} = 1}^{2 t - 1} {\sum }_{{i}_{m} = 1}^{2 m - 1} {h}_{DD , TD} ( {i}_{m} , {i}_{t} ) ,$$

$$when 1 \leq m \leq \frac{{Q}_{DD , k} - 1}{2} , \frac{{Q}_{TD , k} - 1}{2} < t \leq {N}_{FFT} - \frac{{Q}_{TD , k} - 1}{2} ,$$

$${h}_{DD , TD , MAF , k} ( m , t ) = \frac{1}{{Q}_{TD , k} ( 2 m - 1 )} {\sum }_{{i}_{t} = t \frac{{Q}_{TD , k} - 1}{2}}^{t + \frac{{Q}_{TD , k} - 1}{2}} {\sum }_{{i}_{m} = 1}^{2 m - 1} {h}_{DD , TD} ( {i}_{m} , {i}_{t} ) ,$$

$$when 1 \leq m \leq \frac{{Q}_{DD , k} - 1}{2} , {N}_{FFT} - \frac{{Q}_{TD , k} - 1}{2} < t \leq {N}_{FFT} ,$$

$${h}_{DD , TD , MAF , k} ( m , t ) \frac{1}{( 2 ( {N}_{FFT} - t ) + 1 ) ( 2 m - 1 )} {\sum }_{{i}_{t} = 2 t - {N}_{FFT}}^{{N}_{FFT}} {\sum }_{{i}_{m} = 1}^{2 m - 1} {h}_{DD , TD} ( {i}_{m} , {i}_{t} ) ,$$

$$when {h}_{DD , TD , MAF , k} ( m , t ) = \frac{1}{( 2 t - 1 ) {Q}_{DD , k}} {\sum }_{{i}_{t} = 1}^{2 t - 1} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when \frac{{Q}_{DD , k} - 1}{2} < m \leq {N}_{pulse} - \frac{{Q}_{DD , k} - 1}{2} , \frac{{Q}_{TD , k} - 1}{2} < t \leq {N}_{FFT} - \frac{{Q}_{TD , k} - 1}{2} ,$$

$${h}_{DD , TD , MAF , k} ( m , t ) = \frac{1}{{Q}_{TD , k} {Q}_{DD , k}} {\sum }_{{i}_{t} = t - \frac{{Q}_{TD , k} - 1}{2}}^{t + \frac{{Q}_{TD , k} - 1}{2}} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when \frac{{Q}_{DD , k} - 1}{2} < m \leq {N}_{pulse} - \frac{{Q}_{DD , k} - 1}{2} , {N}_{FFT} - \frac{{Q}_{TD , k} - 1}{2} < t \leq {N}_{FFT} ,$$

$${h}_{DD , TD , MAF , k} ( m , t ) = \frac{1}{( 2 ( {N}_{FFT} - t ) + 1 ) {Q}_{DD , k}} {\sum }_{{i}_{t} = 2 t - {N}_{FFT}}^{{N}_{FFT}} {\sum }_{{i}_{m} = m - \frac{{Q}_{DD , k} - 1}{2}}^{m + \frac{{Q}_{DD , k} - 1}{2}} {h}_{DD , TD} ( {i}_{m} , {i}_{t} ) ,$$

$$when {N}_{FFT} - \frac{{Q}_{DD , k} - 1}{2} < m \leq {N}_{pulse} , 1 \leq t \leq \frac{{Q}_{TD , k} - 1}{2} ,$$

$${h}_{DD , TD , MAF , k} ( m , t ) = \frac{1}{( 2 t - 1 ) ( 2 ( {N}_{pulse} - m ) + 1 )} {\sum }_{{i}_{t} = 1}^{2 t - 1} {\sum }_{{i}_{m} = 2 m - {N}_{pulse}}^{{N}_{pulse}} {h}_{DD , TD} ( {i}_{m} , {i}_{t} ) ,$$

$$when {N}_{FFT} - \frac{{Q}_{DD , k} - 1}{2} < m \leq {N}_{pulse} , \frac{{Q}_{TD , k} - 1}{2} \leq t \leq {N}_{FFT} - \frac{{Q}_{TD , k} - 1}{2} ,$$

$${h}_{DD , TD , MAF , k} ( m , t ) = \frac{1}{{Q}_{TD , k} ( 2 ( {N}_{pulse} - m ) + 1 )} {\sum }_{{i}_{t} = t - \frac{{Q}_{TD , k} - 1}{2}}^{t + \frac{{Q}_{TD , k} - 1}{2}} {\sum }_{{i}_{m} = 2 m - {N}_{pulse}}^{{N}_{pulse}} {h}_{DD , TD} ( {i}_{m} , {i}_{t} ) ,$$

$$when {N}_{FFT} - \frac{{Q}_{DD , k} - 1}{2} < m \leq {N}_{pulse} , {N}_{FFT} - \frac{{Q}_{TD , k} - 1}{2} \leq t \leq {N}_{FFT} ,$$

$${h}_{DD , TD , MAF , k} ( m , t ) = \frac{1}{( 2 ( {N}_{FFT} - t ) + 1 ) ( 2 ( {N}_{pulse} - m ) + 1 )} {\sum }_{{i}_{t} = 2 t - {N}_{FFT}}^{{N}_{FFT}} {\sum }_{{i}_{m} = 2 m - {N}_{pulse}}^{{N}_{pulse}} {h}_{DD , TD} ( {i}_{m} , {i}_{t} ) .$$

The difference between h_{DD,TD}(m,t) and h_{DD,TD,MAF,k}(m,t) is calculated, denoted as h_{DD,TD,diff,k}(m,t)=h_{DD,TD}(m,t)−h_{DD,TD,MAF,k}(m,t),m=1, 2, . . . , Nₚᵤₗₛₑ, t=1, 2, . . . , N_{FFT}. Then, two-dimensional over-threshold detection is performed. First, by modeling the noise, the statistical characteristic of the noise is extracted to calculate the power difference threshold. In one implementation, the sensing node estimates the variance of the noise, and generates a noise vector with the corresponding variance by using a simulation method, which is denoted as n₁(t), t=1, . . . , NₚᵤₗₛₑN_{FFT}. n₁ is divided equally into Nₚᵤₗₛₑ parts to obtain n₂(p,t)=n₁((p−1)N_{FFT}+t), where p=1, 2, . . . , Nₚᵤₗₛₑ, t=1, 2, . . . , N_{FFT}. Fourier transform is performed on n₂(p′,t) corresponding to each p′, and windowing with w(n) is performed in frequency domain, and then the time domain noise n̅₂(p′,t), t=1, 2, . . . , N_{FFT} windowed in frequency domain is obtained by inverse Fourier transform. Then, the noise vector n̅₂(p,t′),p=1, 2, . . . , Nₚᵤₗₛₑ corresponding to the t′-th sampling time is subjected to size Nₚᵤₗₛₑ Fourier transform to obtain the Doppler domain channel estimation result corresponding to the t′-th sampling time, which is denoted as n̅₄(m,t′),m=1, 2, . . . , Nₚᵤₗₛₑ. n̅₄(m,t) represents the corresponding noise power at the Doppler frequency m at sampling time t after windowing in frequency domain. By performing the two-dimensional moving average filtering on the noise, the noise power difference thresholds corresponding to two-dimensional moving average filtering with different lengths are determined. In one implementation, it is assumed that the number of times of two-dimensional moving average filtering is N_{MAF}, and in the k-th moving average filtering operation, the moving average filter length in time domain is set to Q_{TD,k}, and the moving average filter length in Doppler domain is set to Q_{DD,k}. In the k-th moving average filtering operation of noise, the moving average filtering result of the noise is obtained by passing n̅₄(m,t′) through the same moving average filter as the above-mentioned filter of h_{DD,TD}(m,t). The difference of n̅₄(m,t′) and N_{MAF,k}(m,t) is calculated, denoted as n_{diff,k}(m,t)=n̅₄(m,t′)−n_{MAF,k}(m,t), and

$${p}_{Th , k} = {max}_{m , t} ( {n}_{diff , k} ( m , t ) )$$

is set as the threshold value corresponding to the filtering operation with the length Q_{TD,k} of the time domain moving average filter and the length Q_{DD,K} of the Doppler domain moving average filter. In actual reception, the sensing node may simulate and generate multiple pieces of noise to process separately, and take the maximum value of multiple

$${max}_{m , t} ( {n}_{diff , k} ( m , t ) )$$

for a certain filter length as the threshold. In addition, when the window length is smaller, in order to prevent the random spike in noise from being determined as the target, when setting the threshold, the typical value Δp may be added to

$${max}_{m , t} ( {n}_{diff , k} ( m , t ) )$$

as the threshold, that is,

$${p}_{T h , k} = {max}_{m , t} ( {n}_{diff , k} ( m , t ) ) + Δ p .$$

Theoretically, the smaller the window length, the larger the typical value should be. Considering the difference between the Doppler domain and the time domain channel estimation results before and after passing through the moving average filter for the k-th time, if ∀t,∀m,h_{DD,TD,diff,k}(m,t)≤p_{Th,k}, it is determined that there is no target in the sensing area; otherwise, a maximum value of h_{DD,TD,diff,k}(m,t) is searched at all (m*, t*) that satisfy h_{DD,TD,diff,k}(m*, t*)>p_{Th,k}. Assuming that Nₖ maximum values are searched after the k-th moving average filtering, in which the position of the i-th maximum value is denoted as (m_{max,k,i}, t_{max,k,i}), the set of maximum value positions is denoted as

$${𝒯}_{k} = {⋃}_{i = 1}^{{N}_{k}} ( {m}_{m ax , k , i} , {t}_{m ax , k , i} ) .$$

Taking the union of the N_{MAF} moving average results, the set of maximum value positions is denoted as

$$𝒯 = {⋃}_{i = 1}^{{N}_{MAF}} {𝒯}_{k} .$$

The number of elements in the set [symbol] is the number of targets sensed at this time, and the elements in the set [symbol] are the Doppler frequency and time domain sampling time corresponding to each target. Accordingly, the target speed at the Doppler frequency m_{max,k,i} is

$$\frac{- ( {m}_{m ax , k , i} - \frac{{N}_{pulse}}{2} - 1 ) \cdot PRF \cdot λ}{2 \cdot {N}_{pulse}} m / s ,$$

where PRF is the repetition frequency of the sensing signal in Hz and Δ is the wavelength of the sensing signal in m. The corresponding target distance at the sampling time t_{max,k,i} is

$$R = \frac{{t}_{m ax , k , i} \cdot c}{2 \cdot {F}_{s}} m ,$$

where c is the speed of light in m/s and Fₛ is the sampling rate in Hz.

Step 3: according to the estimated number of targets and target parameters (the distance between the target and the sensing node and/or the radial velocity of the target relative to the sensing node) from the windowed channel estimation result, the estimation result is corrected by using the windowed channel estimation result. For example, the estimation results of the target number and the target distance may be corrected according to the channel estimation results of the single echo, and the estimation results of the target number, the target distance and the target speed of targets may also be corrected according to the channel estimation results of the multiple echoes.

In one implementation, when the sensing node transmits the single sensing signal and receives the single echo, the resolution unit of the first dimension (the sampling time in the time domain) corresponding to the target distance estimation result in step 2 is found from the channel time domain estimation result, and the detection result is corrected. Among them, the output of the detection result correction operation is the corrected result of the estimated target number and the corrected result of the estimated target distance relative to the sensing node. In one implementation, one of the possible implementations of detection result correction is detection result correction based on maximum search, and another is detection result correction based on platform search.

In the implementation based on maximum search, the resolution unit of the first dimension (the sampling time in the time domain) corresponding to the estimation result of the target distance in step 2 may be found from the channel time domain estimation result, and whether the channel estimation result on the resolution unit is a maximum value may be determined. In one implementation, the criterion for judging the maximum value is that the channel estimation result corresponding to the current resolution unit is greater than the channel estimation result corresponding to its neighboring resolution unit. If the channel estimation result of the resolution unit of the first dimension corresponding to the target distance estimation result in step 2 is the maximum value of the time domain channel estimation result, it is determined that there is a target under the resolution unit, and the distance between the target and the sensing node output in step 2 is the output distance between the target and the sensing node after the result correction; If the channel estimation result of the resolution unit of the first dimension corresponding to the estimation result of step 2 is not the maximum value on the time domain channel estimation result, the maximum value of the time domain channel estimation result is searched near the resolution unit of the first dimension corresponding to the estimation result of step 2, and the number of the maximum values searched is the target number, and the resolution unit of the first dimension corresponding to the maximum value is the sampling time corresponding to the target echo, where the sampling time corresponding to the target echo has a one-to-one correspondence with the distance of the target relative to the sensing node. This design of detection result correction based on maximum search reduces the resolution of parameter estimation and improves the probability of target detection.

In the implementation based on platform search, the resolution unit of the first dimension (sampling time in the time domain) corresponding to the target distance estimation result in step 2 is found from the channel time domain estimation result, and whether the channel estimation result corresponding to the resolution unit is the maximum value is determined. In one implementation, the criterion for judging the maximum value is that the channel estimation result corresponding to the current resolution unit is greater than the channel estimation result corresponding to its neighboring resolution unit. If the channel estimation result of the resolution unit of the first dimension corresponding to the target distance estimation result in step 2 is the maximum value on the time domain channel estimation result, it is determined that there is a target under the resolution unit, and the distance between the target and the sensing node output in step 2 is the output distance between the target and the sensing node after the result correction; if the channel estimation result of the resolution unit of the first dimension corresponding to the estimation result of step 2 is not the maximum value on the time domain channel estimation result, the platform search of the first dimension of the channel estimation result is performed near the resolution unit of the first dimension corresponding to the estimation result of step 2. In one implementation, the criterion for judging the platform is that the channel estimation result corresponding to the current resolution unit is greater than that corresponding to its neighboring resolution unit by Tₚ, where the parameter Tₚ is a real number less than or equal to 0, which is a preset parameter. Optionally, the value of Tₚ may be −0.05, −0.1, −0.15, etc. For example, when the value of Tₚ is −0.15, assuming that the channel estimation result of the current resolution unit is greater than that of the neighboring resolution unit by −0.1, according to the above definition, −0.1>−0.15, that is, −0.1>Tₚ, the system determines that the current resolution unit is “the unit where the platform is located”. Here, that “the channel estimation result of the current resolution unit is greater than that of the neighboring resolution unit by −0.1” is equivalent to the channel estimation result of the current resolution unit being less than that of the neighboring resolution unit by +0.1.

Here, the “platform” corresponds to the “maximum”. In the process of maximum search, the channel estimation result of the current resolution unit is required to be greater than that of the neighboring resolution unit before it may be determined as the “maximum unit”. In the “platform search”, when Tₚ is set to 0.1, in case that the channel estimation result of the current resolution unit is greater than that of the neighboring resolution unit, or the channel estimation result of the current resolution unit is equal to that of the neighboring resolution unit, or the channel estimation result of the current resolution unit is less than that of the neighboring resolution unit by at most 0.1, the current resolution unit may be determined as “the unit where the platform is located”.

In the above example description of platform search, the values of channel estimation results at the comparison resolution unit are taken as an example to explain. However, in some embodiments, the corresponding power values at the resolution units may also be compared with each other, so “platform search” may also be called “power platform search”.

The number of platforms searched by platform search is the target number, and the resolution unit of the first dimension corresponding to the platform is the sampling time corresponding to the target echo, where the sampling time corresponding to the target echo has a one-to-one correspondence with the distance of the target relative to the sensing node. The advantage of this detection result correction design based on platform search is that it improves the detection probability of large targets (that is, targets occupying multiple resolution units).

In one implementation, when the sensing node transmits the multiple sensing signals and receives the multiple echoes, the resolution unit of the first dimension (sampling time in the time domain) and the resolution unit of the second dimension (Doppler frequency) corresponding to the estimation result of step 2 are found from the channel estimation results, and the detection result is corrected. Among them, the output of the detection result correction operation is the number of targets, the distance of the targets relative to the sensing nodes and/or the radial velocity of the targets relative to the sensing nodes. In one implementation, one of the possible implementations of detection result correction is detection result correction based on maximum search, and the other is detection result correction based on platform search.

A specific implementation of the detection result correction based on maximum search is to find the resolution unit of the first dimension and the second dimension corresponding to the estimation result of step 2 from the Doppler-time domain channel estimation result, and determine whether the channel estimation result corresponding to the resolution unit is a maximum value. In one implementation, the criterion for judging the maximum value is that the channel estimation result corresponding to the current resolution unit is greater than the channel estimation result corresponding to its neighboring resolution unit. If the channel estimation result of the resolution unit corresponding to the estimation result in step 2 is the maximum value on the Doppler-time domain channel estimation result, it is determined that there is a target under the resolution unit, and the target parameter output in step 2 is the target parameter after the detection result is corrected. If the channel estimation result of the resolution unit corresponding to the estimation result of step 2 on the Doppler-time domain channel estimation result is not the maximum value, the maximum of the Doppler-time domain channel estimation result is searched near the resolution unit corresponding to the estimation result of step 2, and the number of the maximum values searched is the target number, and the resolution unit of the first dimension corresponding to the maximum value is the sampling time corresponding to the target echo. Among them, there is a one-to-one correspondence between the sampling time corresponding to the target echo and the distance of the target relative to the sensing node, and the resolution unit of the second dimension corresponding to the maximum value is the Doppler frequency of the target, where the Doppler frequency of the target has a one-to-one correspondence with the radial velocity of the target relative to the sensing node. The advantage of this design of detection result correction based on maximum search is to reduce the resolution of parameter estimation and improve the probability of target detection.

A specific implementation of the detection result correction based on platform search is to find the resolution unit of the first dimension and the second dimension corresponding to the estimation result of step 2 from the channel estimation result, and determine whether the channel estimation result corresponding to the resolution unit is the point where the maximum value is located. If the channel estimation result of the resolution unit of the first dimension corresponding to the estimation result in step 2 is a maximum value on the channel estimation result, it is determined that there is a target in this coordinate, and the distance between the target and the sensing node output in step 2 is the distance between the target and the sensing node output after the result is corrected. If the channel estimation result of the resolution unit of the first dimension corresponding to the estimation result of step 2 is not the maximum value on the time domain channel estimation result, the platform search of the Doppler-time domain channel estimation result is performed near the resolution unit corresponding to the estimation result of step 2. In one implementation, the judgment criterion of the power platform is that the channel estimation result corresponding to the current resolution unit is greater than that corresponding to its neighbouring resolution unit by Tₚ, where the parameter Tₚ is a real number less than or equal to 0, which is a preset parameter. Optionally, the value of Tₚ may be −0.05, −0.1, etc. The number of searched power platforms is that target number, and the resolution unit of the first dimension corresponding to the power platforms is the sampling time corresponding to the target echo, where the sampling time corresponding to the target echo has a one-to-one correspondence with the distance of the target relative to the sensing node. The advantage of this detection result correction design based on platform search is that it improves the detection probability of large targets (that is, targets occupying multiple resolution units).

The following gives an example implementation method for the sensing node to correct the detection result of the output result in step 2 of this method according to the windowed Doppler-time domain channel estimation result. Take an example that the sensing node transmits multiple sensing signals and receives multiple echoes, and the detection result correction based on platform search is implemented. The resolution unit corresponding to the elements in the set [symbol] is found from the channel time domain estimation results h_{DD,TD,woWin}(m,t) before windowing, and the detection result correction based on platform search is performed. When the channel estimation result of a certain resolution unit is higher than that of any neighboring resolution unit by Tₚ, it is determined that there is a target on the resolution unit, where the parameter Tₚ is a real number less than or equal to 0, which is a preset parameter. Assuming that N targets are detected from h_{DD,TD}(m,t),m=1, 2, . . . , Nₚᵤₗₛₑ, t=1, 2, . . . , N_{FFT}, in which the resolution unit coordinate corresponding to the ith target is (m_{max,i}, t_{max,i}), i=1, 2, . . . , N. For a certain i=1, 2, . . . , N, if h_{DD,TD,woWin}(m_{max,i}, t_{max,i})−h_{DD,TD,woWin}(m_{max,i}−1, t_{max,i})≥Tₚ, and h_{DD,TD,woWin}(m_{max,i}, t_{max,i})−h_{DD,TD,woWin}(m_{max,i}+1, t_{max,i})≥Tₚ, and h_{DD,TD,woWin}(m_{max,i}, t_{max,i})−h_{DD,TD,woWin}(m_{max,i}, t_{max,i}−1)≥Tₚ, and H_{DD,TD,woWin}(m_{max,i}, t_{max,i})−H_{DD,TD,woWin}(m_{max,i}, t_{max,i}+1)≥Tₚ, it is determined that the target exists at the distance corresponding to the resolution unit (m_{max,i}, t_{max,i}), and accordingly, the target speed at the Doppler frequency is

$$\frac{- ( {m}_{m ax , i} - \frac{{N}_{pulse}}{2} - 1 ) \cdot PRF \cdot λ}{2 \cdot {N}_{pulse}} m / s ,$$

where PRF is the repetition frequency of the sensing signal in Hz and λ is the wavelength of the sensing signal in m. The corresponding target distance at the sampling time t_{max,i} is

$$R = \frac{{t}_{m ax , i} \cdot c}{2 \cdot {F}_{s}} m ,$$

where c is the speed of light in m/s and Fₛ is the sampling rate in Hz; otherwise, r (m*, t*) is searched near the resolution unit (m_{max,i}, t_{max,i}) so that h_{DD,TD,woWin}(m*, t*)−h_{DD,TD,woWin}(m*−1, t*)≥Tₚ, and h_{DD,TD,woWin}(m*, t*)−h_{DD,TD, woWin}(m*+1, t*)≥Tₚ, and h_{DD,TD,woWin}(m*, t*)−h_{DD,TD,woWin}(m*, t*−1)≥Tₚ, and h_{DD,TD,woWin}(m*, t*)−H_{DD,TD,woWin}(m*, t*+1)≥Tₚ, if (m*, t*) exists, the target at the resolution unit (m*, t*) exists. The target speed corresponding to the resolution unit is

$$\frac{- ( {m}^{*} - \frac{{N}_{pulse}}{2} - 1 ) \cdot PRF \cdot λ}{2 \cdot {N}_{pulse}} m / s ,$$

where PRF is the repetition frequency of the sensing signal in Hz and λ is the wavelength of the sensing signal in m; the corresponding target distance is

$$R = \frac{{t}^{*} \cdot c}{2 \cdot {F}_{s}} m ,$$

where c is the speed of light in m/s and Fₛ is the sampling rate in Hz.

The method 3 has the characteristics of good detection performance, high estimation resolution of target distance and speed, supports the detection of different types of targets from the scene, and is more suitable for the identification of multiple point targets in complex environment and large-volume targets in complex environment.

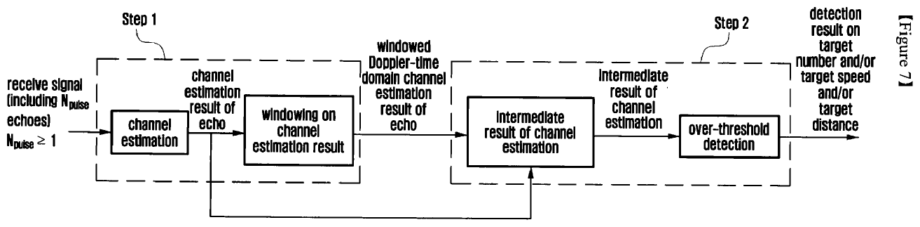

Another feasible target detection method (hereinafter referred to as method 4) receives and processes echo signals for single or multiple sensing signals transmitted by the sensing node to obtain channel estimation results, and determines the distance and/or speed of the target according to the channel estimation results. For example, the distance of the target may be determined according to the channel estimation results of the single echo or the distance and speed of the target may be determined according to the channel estimation results of multiple echoes. The flow is shown in FIG. 7, and the specific steps are as follows:

Step 1: the sensing node transmits a single sensing signal to a sensing area (if a specific transmit beam is used, the specific sensing area is the coverage of the specific transmit beam), receives an echo signal of the sensing signal, performs channel estimation on the echo signal to obtain a channel estimation result of the echo, and performs windowing on the channel estimation result to obtain the windowed channel estimation result.

In one possible implementation, when the sensing node transmits the single sensing signal, the sensing node receives the time domain signal of the echo for the single sensing signal, and performs frequency domain channel estimation on the time domain signal of the single echo to obtain a frequency domain channel estimation result of the single echo; a window function with length N is generated, and the frequency domain channel estimation result with length N is multiplied by the corresponding sample index to obtain the windowed frequency domain channel estimation result. Then the windowed frequency domain channel estimation result is subjected to IDFT/IFFT to obtain the windowed time domain channel estimation result of the single echo. Here, N is the number of sampling points of the single echo, or the maximum length of available time-domain and frequency-domain channel estimation result, and when the length of time-domain and frequency-domain channel estimation results is also N, N is also the size of DFT/FFT/IDFT/IFFT between time-domain and frequency-domain channels. In one implementation, the time domain channel estimation may also be performed on the time domain signal of the single echo to obtain the time domain channel estimation result of the single echo; a window function with length N is generated, and size N IDFT/IFFT is performed on the window function to obtain a time domain expression of the window function with length N. The time domain channel estimation result of the single echo is convolved with the time domain expression of the window function to obtain the windowed time domain channel estimation result of the single echo.

Step 2: the sensing node processes the channel estimation result and the windowed channel estimation result, and performs over-threshold detection on the processing result to obtain the number of output targets, and obtains at least one of the following estimations: the distance from the target to the sensing node and the radial velocity of the target relative to the sensing node. Among them, the distance of the target from the sensing node means the distance from the sensing node to the target, and the radial velocity of the target relative to the sensing node means the component of the target velocity in the vertical direction of the connecting line between the target and the sensing node.

In one implementation, when the sensing node transmits the single sensing signal and receives the single echo, the sensing node processes the channel estimation result of the single echo and the windowed channel estimation result to obtain an intermediate result of the channel estimation, and performs a first-stage over-threshold detection on the intermediate result of the channel estimation, where the first-stage over-threshold detection may output the distance between the number of targets and the sensing node.

One implementation of processing the channel estimation result of the single echo and the windowed channel estimation result and obtaining the intermediate result of channel estimation may be to extract the envelope of the channel estimation result and the windowed channel estimation result respectively to obtain the envelope of the channel estimation result and the envelope of the windowed channel estimation result. Difference is made between the envelope of the channel estimation result and the envelope of the windowed channel estimation result to obtain the intermediate result of channel estimation. The envelope of the channel estimation result may be the envelope of the power of the channel estimation result in time domain or Doppler domain. The envelope of the channel estimation result may reflect the trend of the peak value of the main lobe and each sidelobe of the echo of the target in the channel estimation result, and may further reflect the changing trend of the high-frequency component (that is, the component that changes faster) in the channel estimation result with a certain physical quantity. For example, the envelope of time domain channel estimation results may reflect the changing trend of high frequency components in channel estimation results with time, and the envelope of Doppler domain channel estimation results may reflect the changing trend of high frequency components in channel estimation results with Doppler frequency.

A specific implementation of the first-stage over-threshold detection is to compare the time-domain channel estimation result obtained from the single echo with a threshold value (or optionally referred to as a “threshold” in this paper, for example, a power threshold), and search for a maximum value in an area in which the power threshold is exceeded. At this time, the number of maximum values searched is the estimated number of targets, and there is a one-to-one correspondence between the resolution unit corresponding to the maximum value (that is, the sampling time) and the distance between the target and the sensing node. Among them, the area in which the threshold is exceeded refers to the resolution unit corresponding to the time domain channel estimation result whose value exceeds the power threshold, that is, the channel estimation value corresponding to the resolution unit in the area in which the power threshold is exceeded is greater than the power threshold. It should be understood that in the scenario of single sensing signal, the resolution unit or coordinate resolution unit corresponds to the sampling time, and the resolution unit, coordinate resolution unit or sampling time may also be called an index, for example, an index in the first dimension. In one implementation, the power threshold may be a fixed value or a real-time calculated value or a non-real-time calculated value related to the statistical characteristic of noise, for example, the sensing node obtains the statistical characteristic such as the mean and/or variance of the noise for calculation of the power threshold, and the sensing node may obtain the noise in real time by channel estimation based on the echo signal, or set a fixed noise variance according to empirical values or theoretical values. Among them, the real-time calculated value may mean that the sensing node may estimate the noise of the echo for the sensing signal transmitted each time for calculation of the power threshold, and the design of the real-time power threshold has the beneficial effect of improving the accuracy of the system; the non-real-time calculated value may mean that the sensing node estimates the noise of the echo for a sensing signal transmitted at a certain time, which is used for calculation of the power threshold, and the power threshold is used to detect the target in the echo for the sensing signal transmitted several times later. The design of this non-real-time power threshold has the beneficial effects of reducing the estimation times and reducing the calculation complexity. After obtaining the statistical characteristic such as the mean and/or variance of the noise, the power threshold may be set as a function related to the statistical characteristic of the noise, for example, the power threshold is set as a linear combination of the mean and variance of the noise. The design and operation of this power threshold are simple and the calculation complexity is low.

The following gives an example implementation method that the sensing node processes the channel estimation result of the single echo and the windowed channel estimation result to obtain an intermediate result of channel estimation, and performs the first-stage over-threshold detection on the intermediate result of channel estimation. The following gives a specific implementation method of the first-stage over-threshold detection by the sensing node according to the echo signal of the single sensing signal. The number of sensing signals transmitted by the sensing node is Nₚᵤₗₛₑ=1, and the channel estimation result is expressed as h̅_{TD}(t) where t=1, 2, . . . , N_{FFT}, the windowed channel estimation result is h_{TD}(mt), where t=1, 2, . . . , N_{FFT}. The envelope of the channel estimation result h̅_{TD}(t) is extracted to obtain the envelope of the channel estimation result. For example, one of the ways to obtain the envelope is

$${\overline{h}}_{TD , En} ( t ) = \{ \begin{matrix}{\overline{h}}_{T D} ( t ) , t = 1 \\ {\overline{h}}_{T D} ( t ) , 1 < t < {N}_{FFT} , {\overline{h}}_{T D} ( t ) > {\overline{h}}_{T D} ( t - 1 ) , {\overline{h}}_{T D} ( t ) > {\overline{h}}_{T D} ( t + 1 ) \\ {\overline{h}}_{T D} ( t - 1 ) , else\end{matrix} ,$$

where t=1, 2, . . . , N_{FFT}. The envelope of the windowed channel estimation result h_{TD}(t) is extracted to obtain the envelope of the channel estimation result. For example, one of the ways to obtain the envelope is

$${h}_{TD , En} ( t ) = \{ \begin{matrix}{h}_{T D} ( t ) , t = 1 \\ {h}_{T D} ( t ) , 1 < t < {N}_{FFT} , {h}_{T D} ( t ) > {h}_{T D} ( t - 1 ) , {h}_{T D} ( t ) > {h}_{T D} ( t + 1 ) \\ {h}_{T D} ( t - 1 ) , else\end{matrix} .$$

Difference is made between the envelope of the channel estimation result h̅_{TD,En}(t) and the envelope of the windowed channel estimation result h_{TD,En}(mt) to obtain an intermediate result of channel estimation, which is expressed as Δh_{TD,En}(t)=h̅_{TD,En}(t)−h_{TD,En}(t). Taking setting a fixed power threshold p_{Th} as an example, the intermediate result of channel estimation is detected by the first-stage threshold crossing. If ∀t,Δh_{TD,En}(t)≤p_{Th}, it is determined that there is no target in the sensing area; otherwise, a maximum value of h_{TD}(t) is searched at all t* that satisfy Δh_{TD,En}(t*)>p_{Th}. Assuming that N maximum values exceeding the threshold is searched from a single echo, in which the resolution unit corresponding to the i-th maximum value is denoted as t_{max,i}, and the resolution unit set corresponding to the maximum value searched from a single echo is denoted as

$$𝒯 = {⋃}_{i = 1}^{N} {t}_{ma x , i} .$$

The number of elements in the set is the number of targets sensed from this echo, and the element in the set [symbol] are the sampling time corresponding to each target sensed from this echo. Accordingly, the corresponding target distance at the sampling time t_{max,i} is

$$R = \frac{{t}_{m ax , i} \cdot c}{2 \cdot {F}_{s}} ,$$

in meters (m), where c is the speed of light in m/s and Fₛ is the sampling rate in Hz.

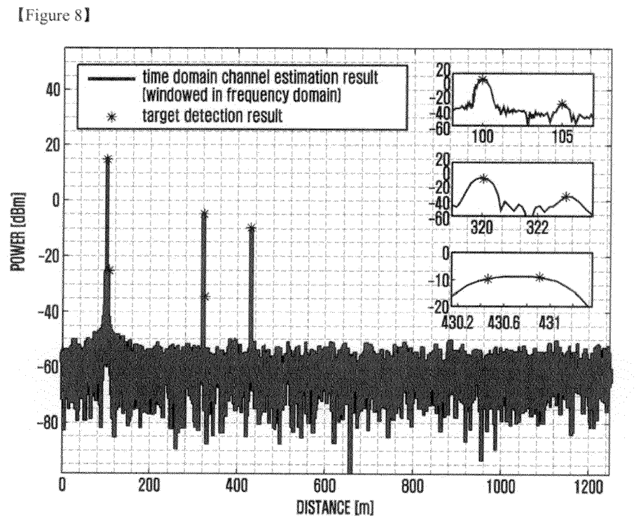

FIG. 8 shows an example implementation result of the method 3 proposed in the disclosure, in which step 2 of the second method is adopted as the implementation method of step 2 of the method 3 to perform target detection and parameter estimation. As a sensing node, a base station senses the distance range from 0 to 1250 meters within a certain beam range. The sensing signal selected by the sensing node is downlink DMRS signal, and the frequency domain channel estimation and frequency domain windowing are performed for the single echo. In this simulation, Kaiser window with a weighting function parameter of 5 is selected. The operating frequency of the sensing node is 28 GHz, the subcarrier spacing is 120 kHz, and the size of Fourier transform is N_{FFT}=8192. There are 6 point targets in the environment, the distance of target 1 is R₁=100 m, and the radar cross-sectional area is S₁=10; the distance of target 2 is R₂=105 m, and the radar cross-sectional area is S₂=0.5; the distance of target 3 is R₃=320.08 m, and the radar cross-sectional area is S₃=10; The distance of target 4 is R₄=323.08 m, and the radar cross-sectional area is S₄=1; the distance of target 5 is R₅=430.47 m, and the radar cross-sectional area is S₅=10; the distance of target 6 is R₆=430.94 m, and the radar cross-sectional area is S₆=10; as shown in FIG. 8, the number of targets estimated this time is 6, in which the distance estimation result of target 1 is \hat{R}₁=99.95 m, the distance estimation result of target 2 is \hat{R}₂=104.98 m, the distance estimation result of target 3 is \hat{R}₃=320.13 m, the distance estimation result of target 4 is \hat{R}₄=323.03, the distance estimation result of target 5 is \hat{R}₅=430.45 m, and the distance estimation result of target 6 is \hat{R}₆=430.45 m.

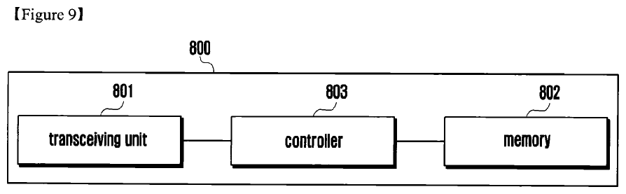

FIG. 9 shows a simplified block diagram of an apparatus 800 according to an embodiment of the disclosure. It should be understood that, for the sake of brevity, only components directly related to the disclosure are shown, while other components that may be needed are omitted from the drawings so as not to obscure the gist of the disclosure.

As shown in FIG. 9, the device 800 includes a transceiver unit 801, a memory 802, and a controller 803.

The transceiving unit 801 is configured to receive and/or transmit signals.

The controller 803 is operatively connected to the transceiver unit 801 and the memory 802. The controller 803 may be implemented as one or more processors for operating according to any one or more of the methods described in various embodiments of the disclosure.

The memory 802 is configured to store computer programs and data. The memory 802 may include a non-transitory memory for storing operations and/or code instructions executable by the controller 803. The memory 802 may include non-transitory programs and/or instructions readable by the controller, which, when executed, cause the controller 803 to implement the steps of any one or more methods according to various embodiments of the disclosure. The memory 802 may also include a random access memory or buffer(s) to store intermediate processing data from various functions performed by the controller 803.

Those skilled in the art will understand that the illustrative embodiments described above are described herein and are not intended to be limiting. It should be understood that any two or more of the embodiments disclosed herein may be combined in any combination. In addition, other embodiments may be utilized and other changes may be made without departing from the spirit and scope of the subject matter presented herein. It will be readily understood that aspects of the invention of the disclosure, as generally described herein and shown in the accompanying drawings, may be arranged, substituted, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above is only exemplary embodiments of the present invention, and is not used to limit the scope of protection of the invention, which is determined by the appended claims.

1-15. (canceled)

16. A method performed by a node in a communication system, the method comprising:
transmitting, to at least one target, at least one sensing signal;
obtaining a first channel estimation result corresponding to at least one echo signal of the at least one sensing signal;
obtaining a second channel estimation result based on the first channel estimation result;
based on the first channel estimation result and the second channel estimation result, performing an over-threshold detection based on a threshold value being used to obtain an index subset related to at least one target; and
obtaining an over-threshold detection result based on the index subset related to the at least one target.

17. The method of claim 16, wherein the over-threshold detection comprises:
obtaining a first envelope of the first channel estimation result and a second envelope of the second channel estimation result; and
performing the over-threshold detection based on at least one of the threshold value or a difference between the first envelope and the second envelope,
wherein the over-threshold detection result comprises at least one of:
a number of targets obtained according to a number of indexes in the index subset;
a distance and/or speed of the target determined based on values of the indexes in the index subset.

18. The method of claim 16, further comprising:
obtaining a third channel estimation result based on the second channel estimation result;
performing over-threshold detection based on at least one of the threshold value being used to obtain the index subset related to the at least one target, the second channel estimation result, or the third channel estimation result; and
obtaining the over-threshold detection result based on the index subset related to the at least one target.

19. The method of claim 18, wherein the second channel estimation result is a two-dimensional channel estimation result, and the method further comprises:
obtaining an average of the second channel estimation result in one of dimensions,
wherein the obtaining the third channel estimation result comprises obtaining the third channel estimation result based on the average of the second channel estimation result, and
wherein the over-threshold detection comprises performing the over-threshold detection based on a difference between the average of the second channel estimation result and the third channel estimation result and the threshold value.

20. The method of claim 18, wherein the second channel estimation result is a two-dimensional channel estimation result, and
wherein the obtaining the third channel estimation result and the over-threshold detection comprises:
performing first process on the second channel estimation result in one of two dimensions;
performing first over-threshold detection to obtain a third index set according to a difference between the first processed channel estimation result and the second channel estimation result and a first threshold;
obtaining a subset of the second channel estimation result corresponding to the third index set for another of the two dimensions;
performing second process on the subset of the second channel estimation result in the other dimension;
performing second over-threshold detection to obtain the index subset according to a difference between the processed subset of the second channel estimation result and the subset of the second channel estimation result and a second threshold,
wherein the obtaining the third channel estimation result is performed by using a two-dimensional filter.

21. The method of claim 18, wherein the obtaining the third channel estimation result comprises obtaining a plurality of third channel estimation results based on the second channel estimation result by using a plurality of different filters respectively,
wherein the over-threshold detection comprises: for each third channel estimation result of the plurality of third channel estimation results, based on a difference between the third channel estimation result and the second channel estimation result and a threshold value, performing the over-threshold detection to obtain a third index subset related to the third channel estimation result, and
wherein the index subset is a union of the third index subsets related to the third channel estimation results,
wherein the filter is a moving average filter or a cyclic moving average filter.

22. The method of claim 18, wherein a filter length corresponding to the obtaining a plurality of third channel estimation results is related to a cross-sectional area of the target that a system expects to detect or a range of the cross-sectional area of the target that the system expects to detect,
wherein the threshold value is obtained by:
obtaining the threshold value according to a statistical characteristic of a noise related to reception of the echo signal; or
generating a first random noise based on the statistical characteristic of the noise, obtaining a second noise based on the first random noise, and
obtaining the threshold value based on a noise difference between the second noise and the first random noise,
wherein the threshold value obtained based on the difference between the second noise and the first random noise is a maximum value of the noise difference, or a sum of the maximum value and a typical value,
wherein the typical value is inversely proportional to the filter length corresponding to the filtering.

23. The method of claim 18, wherein the obtaining of the detection result about the target based on the index subset comprises:
obtaining a second index subset related to the target based on the first channel estimation result and the index subset;
obtaining the detection result about the target based on the second index subset,
wherein the second index subset comprises:
a first index of the index subset to which the first channel estimation result corresponds is a maximum value, and
a third index, which comprises one or more indexes determined within a first range corresponding to a second index based on the first channel estimation result, the second index being an index of the index subset to which the first channel estimation result corresponds is not the maximum value, wherein each index within the first range is from the index subset and a difference between the index and the second index is not greater than a first threshold,
wherein the third index comprises:
an index of the maximum value within the first range corresponding to the second index; and/or
an index within the first range corresponding to the second index, a difference between the first channel estimation result corresponding to the index and the first channel estimation result corresponding to the second index being not less than a second threshold, wherein the second threshold is less than or equal to zero.

24. A node in a communication system, the node comprising:
a transceiver; and
at least one processor coupled with the transceiver and configured to:
transmit, to at least one target, at least one sensing signal,
obtain a first channel estimation result corresponding to at least one echo signal of the at least one sensing signal,
obtain a second channel estimation result based on the first channel estimation result,
based on the first channel estimation result and the second channel estimation result, perform an over-threshold detection based on a threshold value being used to obtain an index subset related to at least one target, and
obtain an over-threshold detection result based on the index subset related to the at least one target.

25. The node of claim 24, wherein the over-threshold detection comprises:
obtaining a first envelope of the first channel estimation result and a second envelope of the second channel estimation result; and
performing the over-threshold detection based on at least one of the threshold value or a difference between the first envelope and the second envelope,
wherein the over-threshold detection result comprises at least one of:
a number of targets obtained according to a number of indexes in the index subset;
a distance and/or speed of the target determined based on values of the indexes in the index subset.

26. The node of claim 24, wherein the at least one processor is further configured to:
obtain a third channel estimation result based on the second channel estimation result,
perform over-threshold detection based on at least one of the threshold value being used to obtain the index subset related to the at least one target, the second channel estimation result, or the third channel estimation result, and
obtain the over-threshold detection result based on the index subset related to the at least one target.

27. The node of claim 26, wherein the second channel estimation result is a two-dimensional channel estimation result, and the at least one processor is further configured to:
obtain an average of the second channel estimation result in one of dimensions,
wherein the obtaining the third channel estimation result comprises obtaining the third channel estimation result based on the average of the second channel estimation result, and
wherein the over-threshold detection comprises performing the over-threshold detection based on a difference between the average of the second channel estimation result and the third channel estimation result and the threshold value.

28. The node of claim 26, wherein the second channel estimation result is a two-dimensional channel estimation result, and
wherein the at least one processor is further configured to:
perform first process on the second channel estimation result in one of two dimensions,
perform first over-threshold detection to obtain a third index set according to a difference between the first processed channel estimation result and the second channel estimation result and a first threshold,
obtain a subset of the second channel estimation result corresponding to the third index set for another of the two dimensions,
perform second process on the subset of the second channel estimation result in the other dimension,
perform second over-threshold detection to obtain the index subset according to a difference between the processed subset of the second channel estimation result and the subset of the second channel estimation result and a second threshold,
wherein the obtaining the third channel estimation result is performed by using a two-dimensional filter.

29. The node of claim 26, wherein the at least one processor is further configured to obtain a plurality of third channel estimation results based on the second channel estimation result by using a plurality of different filters respectively,
wherein the over-threshold detection comprises: for each third channel estimation result of the plurality of third channel estimation results, based on a difference between the third channel estimation result and the second channel estimation result and a threshold value, performing the over-threshold detection to obtain a third index subset related to the third channel estimation result, and
wherein the index subset is a union of the third index subsets related to the third channel estimation results,
wherein the filter is a moving average filter or a cyclic moving average filter.

30. The node of claim 26, wherein a filter length is related to a cross-sectional area of the target that a system expects to detect or a range of the cross-sectional area of the target that the system expects to detect,
wherein the at least one processor is further configured to:
obtain the threshold value according to a statistical characteristic of a noise related to reception of the echo signal, or
generate a first random noise based on the statistical characteristic of the noise, obtaining a second noise based on the first random noise, and
obtain the threshold value based on a noise difference between the second noise and the first random noise,
obtain a second index subset related to the target based on the first channel estimation result and the index subset,
obtain the detection result about the target based on the second index subset,
wherein the threshold value obtained based on the difference between the second noise and the first random noise is a maximum value of the noise difference, or a sum of the maximum value and a typical value,
wherein the typical value is inversely proportional to the filter length corresponding to the filtering,
wherein the second index subset comprises:
a first index of the index subset to which the first channel estimation result corresponds is a maximum value, and
a third index, which comprises one or more indexes determined within a first range corresponding to a second index based on the first channel estimation result, the second index being an index of the index subset to which the first channel estimation result corresponds is not the maximum value, wherein each index within the first range is from the index subset and a difference between the index and the second index is not greater than a first threshold,
wherein the third index comprises:
an index of the maximum value within the first range corresponding to the second index; and/or
an index within the first range corresponding to the second index, a difference between the first channel estimation result corresponding to the index and the first channel estimation result corresponding to the second index being not less than a second threshold, wherein the second threshold is less than or equal to zero.
